(19) United States
(12) Patent Application Publication
(10) Pub. No.: US 2005/0270986 A1
(43) Pub. Date: Dec. 8, 2005

(54) Apparatus and method for topology discovery among network devices

(75) Inventors: Yukihiro Watanabe, Kawasaki (JP); Keiichi Oguro, Kawasaki (JP); Kuniaki Shimada, Kawasaki (JP); Ken Yokoyama, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/973,211

(22) Filed: Oct. 26, 2004

(30) Foreign Application Priority Data
Jun. 2, 2004 (JP) 2004-164778

(51) Int. Cl. H04L 12/26

(52) U.S. Cl. 370/252; 370/469

(57) ABSTRACT

Connections included in the topology of a lower-order layer of a plurality of layers are grouped according to device setting information of a plurality of devices composing a communication network with a communication function having a hierarchical structure composed of the plurality of layers, and an information reach range in a higher-order layer is generated. Then, the topology of the higher-order layer is generated based on the obtained information reach range.

### BACKGROUND OF THE INVENTION

1. Field of the Invention

The present invention relates to the operation management of a communication network composed of a plurality of devices, and more particularly an apparatus for searching for both the device configuration of a network and the physical/logical connection configuration of those devices, and a method thereof.

2. Description of the Related Art

In the operation management of a communication network whose scale is increasing, it is important to obtain/manage the physical/logical connection configuration (hereinafter called “topology”) of devices composing a network. A physical connection configuration means the connection state of devices in the physical layer of the hierarchical structure of communication functions, and a logical connection configuration means the connection state of devices in a layer higher than the physical layer.

Conventionally, a topology management technology has been developed, and generally the network manager detects devices in a network using a tool utilizing the technology. Such a tool lists up devices in the same network in the Internet protocol (IP) layer of the network, and provides a user with information about the setting of each device and the like. Information which can be made manageable by such a tool is as follows.
(1) Topology in which devices are grouped in sub-net units of an IP layer
(2) Topology among devices in a physical layer

Each of the following Patent References 1, 2 and 3 discloses a network management technology.
Patent Reference 1: Japanese Patent Application Laid-open No. 2001-211178
Patent Reference 2: Japanese Patent Application Laid-open No. 2000-078135
Patent Reference 3: Japanese Patent Application Laid-open No. 2003-115843

However, in the conventional network management technology, with the promotion of a large-scale/complex network and the progress of a network technology, the following problems have appeared.
(1) Conventionally, network management was largely grouped into two categories; the management of network devices for transmitting data and the management of server devices for providing job application. The former managed their topology for assuring the transmission of data, and the latter monitored load in order to assure the operation of application.

Since conventional network device mainly transmitted data in the IP layer or a layer lower than the IP layer, of a network, even in the topology management, a management target was the topology of the IP layer or a layer lower than the IP layer.

Since network device management and server device management independently managed only an IP layer and only an application layer, respectively, there was no means for linking both management means.

However, thanks to recent technological innovation, network device has enabled not only the transmission of data in the IP layer or a layer lower than the IP layer, but also services, such as packet filtering, distribution of load and the like, in a higher-order layer.

The performance of some server device has been improved by controlling up to a layer lower than the conventional layer, and as a result, the boundary between a network device and a server device has become unclear compared with that of the prior art.

Such a device cannot be sufficiently managed by the conventional management of only a lower-order layer or only the conventional management of only a higher-order layer, and a new technology for integrating and managing higher-order and lower-order layers is necessary.

The conventional topology management method independently managed each layer. However, in order to assure the transmission of data in a higher-order layer, not only the transmission of data in the higher-order layer but that in a lower-order layer must be also assured. For this reason, instead of independently managing topology for each layer, a management method for linking a higher-order layer with a lower-order layer is necessary.
(2) In a network service, such as job application and the like, data is transmitted/received using a lower-order layer device, such as a switch and the like. In this case, in the prior art, since a method for linking a higher-order layer and a lower-order layer was not established, neither a device used to transmit/receive data nor a route taken by the data could not be detected. If there was a failure in a specific device, a service affected by the failure could not be also detected.
(3) Furthermore, the conventional topology management technology presumes that the manager obtains the topology of the physical layer of a network and then manually inputs information to a management tool. Ina large-scale network, this input work takes much time and also becomes one major factor of an artificial mistake.

### SUMMARY OF THE INVENTION

It is an object of the present invention to discover the topology among a plurality of devices in a communication network with a communication function having a hierarchical structure composed of a plurality of layers, while linking the topology of a lower-order layer with that of a higher-order layer.

It is another object of the present invention to detect a device used to communicate by application and its route in a communication network with a communication function having a hierarchical structure composed of a plurality of layers.

It is another object of the present invention to reduce time needed to input information about the topology of the physical layer of a communication network.

The first topology discover apparatus of the present invention comprises a storage device, a generation device and an output device, and discovers the topology among a plurality of devices composing a communication network with a communication function having a hierarchical structure composed of a plurality of layers. The storage device stores the device setting information of the plurality of devices. The generation devices groups connections included in the topology of a lower-order layer of a plurality of layers, according to the device setting information, generates an information reach range of a higher-order layer and generates the topology of the higher-order layer, based on the information reach range. The output device outputs information about the generated topology.

The second topology discover apparatus of the present invention comprises a storage device and a generation device, and discovers topology among a plurality of devices composing a communication network. The storage device stores the device setting information of the plurality of devices. The generation device generates information about physical connections among the plurality of devices, using information about the media access control address of each interface of each device included in the device setting information.

### BRIEF DESCRIPTION OF THE DRAWINGS

FIG. 1 shows the basic configuration of the topology discover apparatus of the present invention;

FIG. 2 shows the first topology discover apparatus;

FIG. 3 shows the model of multi-layer topology;

FIG. 4 shows linkage between layers;

FIG. 5 shows the configuration of the first topology discover apparatus;

FIG. 6 shows an example of the topology of a physical layer;

FIG. 7 shows an example of the topology of an MAC layer;

FIG. 8 shows an example of the topology of an IP layer;

FIG. 9 shows an example of the topology of a TCP/UDP layer;

FIG. 10 shows an example of the topology of an application layer;

FIG. 11 shows an example of device setting information;

FIG. 12 shows the topology data of a physical layer;

FIG. 13 shows the topology data of an MAC layer;

FIG. 14 shows the topology data of an IP layer;

FIG. 15 shows the topology data of a TCP/UDP layer;

FIG. 16 shows the topology data of an application layer;

FIG. 17 is a flowchart showing an MAC layer topology discovering process;

FIG. 18 is a flowchart showing an IP layer topology discovering process:

FIG. 19 is a flowchart showing a TCP/UDP layer topology discovering process;

FIG. 20 is a flowchart showing an application layer topology discovering process;

FIG. 21 shows the second topology discover apparatus;

FIG. 22 shows the configuration of the second topology discover apparatus;

FIG. 23 shows the data structure of a connector;

FIG. 24 is a flowchart showing a route discovering process (No. 1);

FIG. 25 is a flowchart showing a route discovering process (No. 2);

FIG. 26 is a flowchart showing a route discovering process (No. 3);

FIG. 27 is a flowchart showing a route discovering process (No. 4);

FIG. 28 is a flowchart showing a route discovering process (No. 5);

FIG. 29 is a flowchart showing a route discovering process (No. 6);

FIG. 30 is a flowchart of a destination searching process;

FIG. 31 shows the VLAN setting of a switch,

FIG. 32 shows the MAC learning table of a switch.

FIG. 33 shows the MAC address of each device;

FIG. 34 shows the third topology discover apparatus;

FIG. 35 shows the configuration of the third topology discover apparatus;

FIG. 36 shows a physical connection;

FIG. 37 shows a physical connection discovering process;

FIG. 38 is a flowchart showing an inter-switch connection discovering process;

FIG. 39 a flowchart showing a switch-terminal connection discovering process;

FIG. 40 shows the configuration of an information processing device; and

FIG. 41 shows how to provide a program and data.

### DESCRIPTION OF THE PREFERRED EMBODIMENTS

The preferred embodiments of the present invention are described in detail below with reference to the drawings.

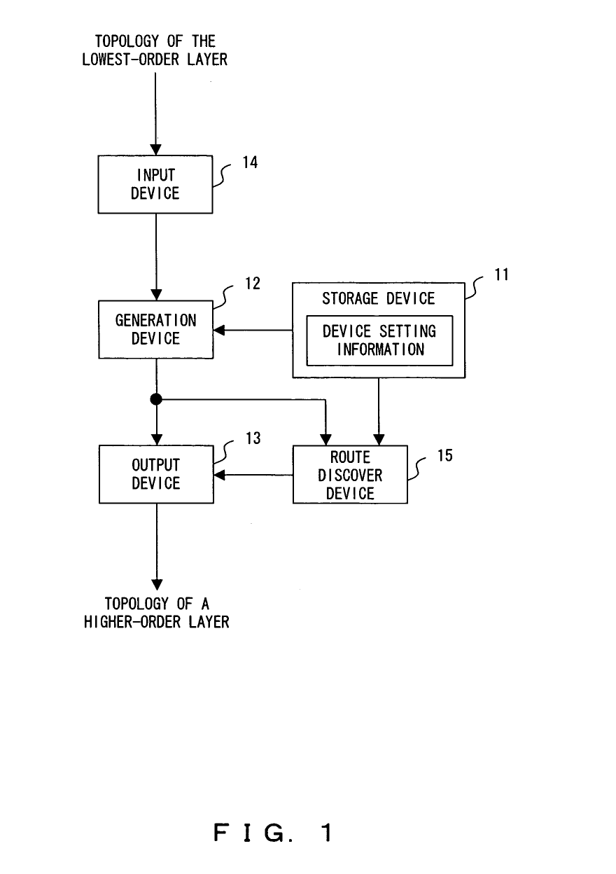

FIG. 1 shows the basic configuration of the topology discover apparatus of the present invention.

In the first aspect of the present invention, the topology discover apparatus comprises a storage device 11, a generation device 12 and an output device 13, and discovers the topology among a plurality of devices composing a communication network with a communication function having a hierarchical structure composed of a plurality of layers. The storage device 11 stores the device setting information of the plurality of devices. The generation devices 12 groups connections included in the topology of a lower-order layer of a plurality of layers, according to the device setting information, generates an information reach range of a higher-order layer and generates the topology of the higher-order layer according to the information reach range. The output device 13 outputs information about the generated topology.

In the second aspect of the present invention, the topology discover apparatus in the first aspect further comprises an input device 14. The input device 14 inputs information about the topology of the lowest-order layer of the plurality of layers. The generation device 12 generates the topology of each layer ranging from a layer immediately higher than the lowest-order up to the highest-order layer repeating a process of sequentially generating the topology of an immediately higher-order layer starting from that of the lowest-order layer.

In the third aspect of the present invention, the topology discover apparatus in first or second aspect further comprises a route discover device 15. The route discover device 15 searches for a data passing route of a designated application service, between two devices in a communication network, using both the above-mentioned device setting information and information about the respective topology of a lower-order layer and a higher-order layer. The output device 13 outputs information about the data passing route.

In the fourth aspect of the present invention, the topology discover apparatus comprises a storage device 11 and a generation device 12, and discovers topology among a plurality of devices composing a communication network. The storage device 11 stores the device setting information of the plurality of devices. The generation device 12 generates information about physical connections among the plurality of devices, according to information about the media access control address of each interface of each device included in the device setting information.

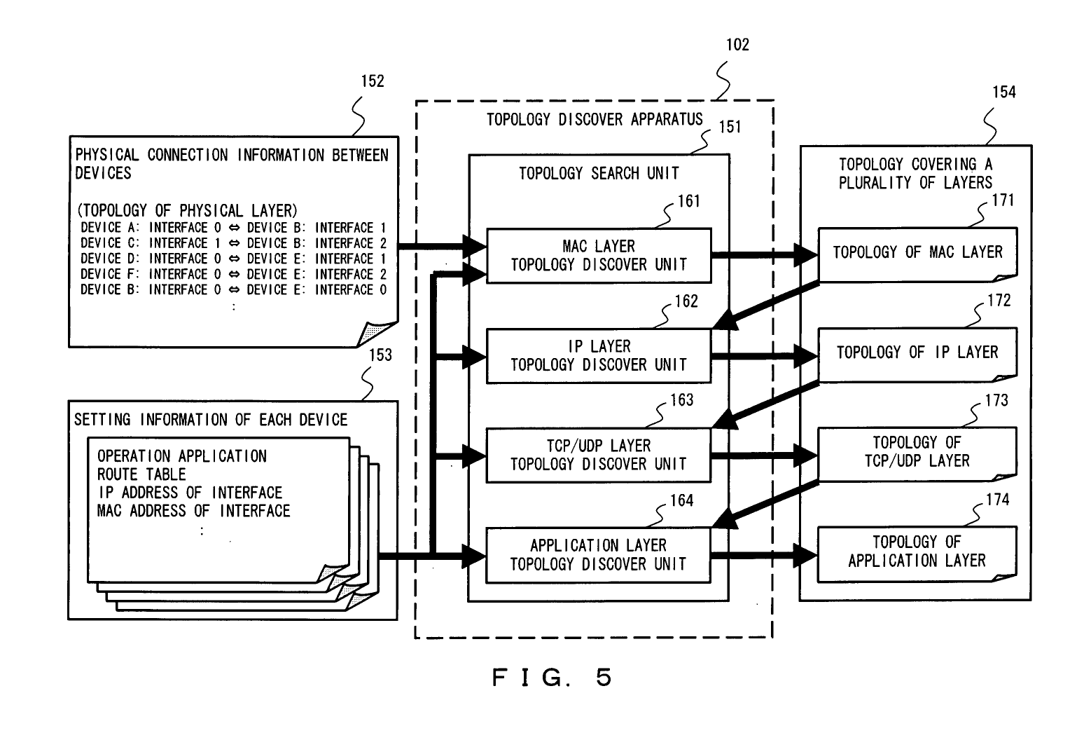

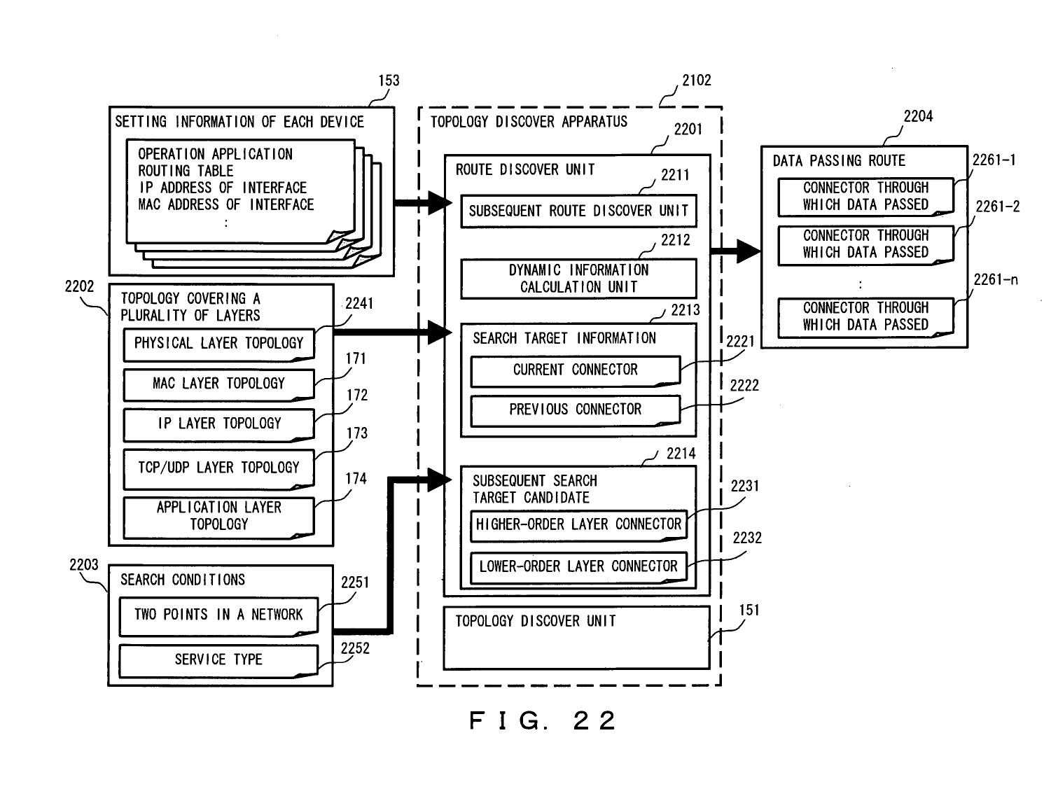

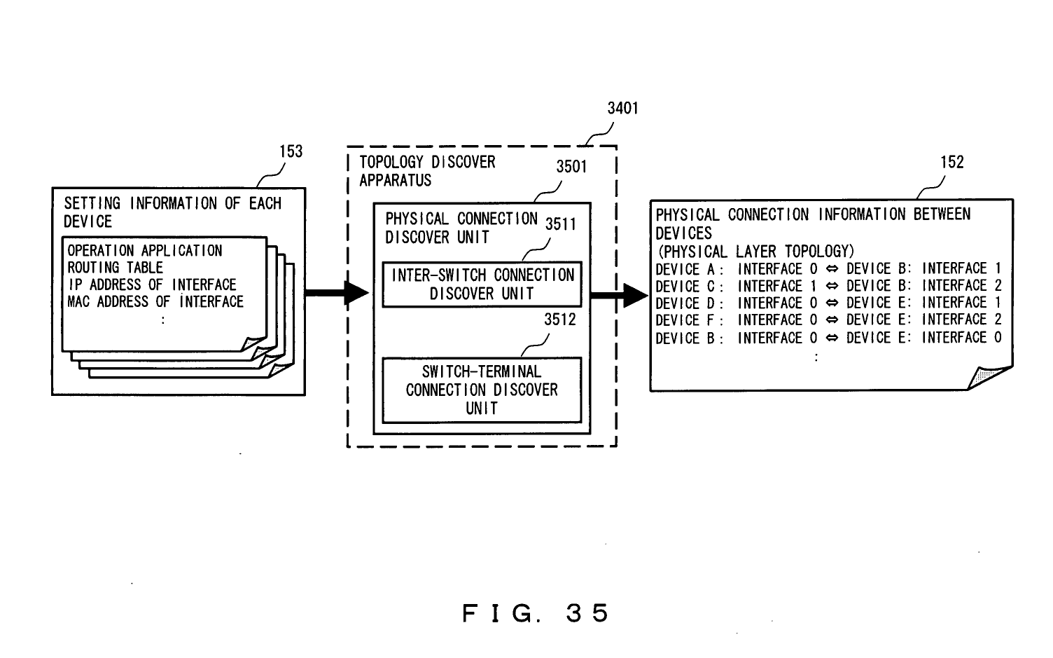

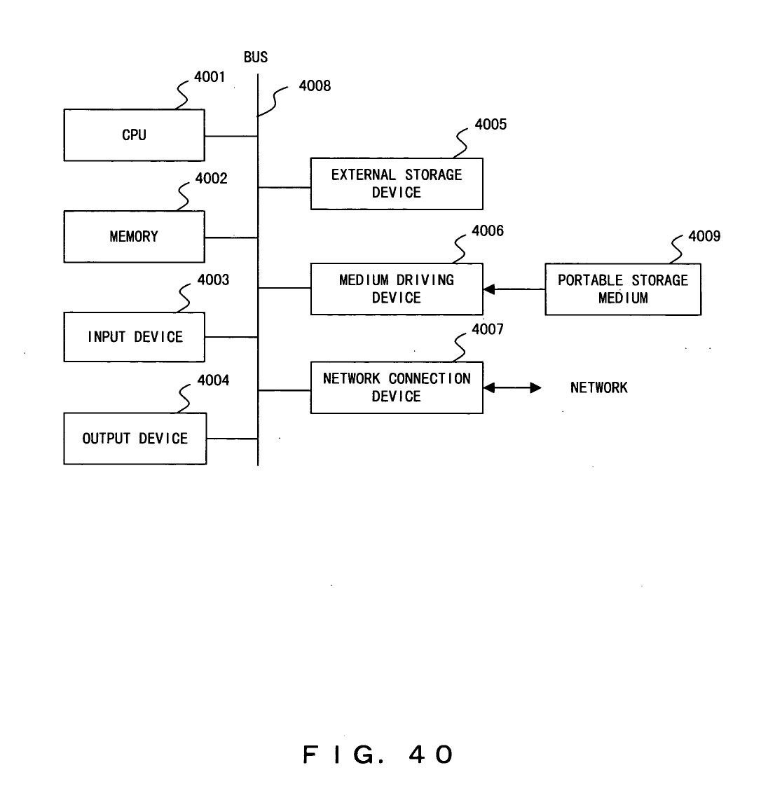

The storage device 11, the output device 13 and the input device 14, for example, correspond to memory 4002, output device 4004 and input device 4003, respectively, shown in FIG. 40, which is described later. The generation device 12, for example, corresponds to a topology discover unit 151 shown in FIG. 5, which is described later, and a physical connection discover unit 3501 shown in FIG. 35, which is also described later. The route discover device 15, for example, corresponds to a route discover unit 2201 shown in FIG. 22, which is described later.

According to the present invention, in the hierarchical structure of a communication function, integrated topology taking into consideration linkage between layers can be calculated as to all layers including layers higher than an IP layer which cannot be conventionally expressed. In a higher-order layer, secure data reachability supported by the data reachability in a lower-order layer can be verified.

According to the present invention, devices used to communicate by application and its route can be calculated. Thus, if there is a failure in a device of a network, service coverage affected by the failure can also be calculated.

According to the present invention, even in a large-scale network, information about the physical connection between devices, needed to manage configuration can be automatically generated. Therefore, there is no need to manually input the information. Accordingly, artificial mistakes are prevented, and a more accurate network configuration can be obtained.

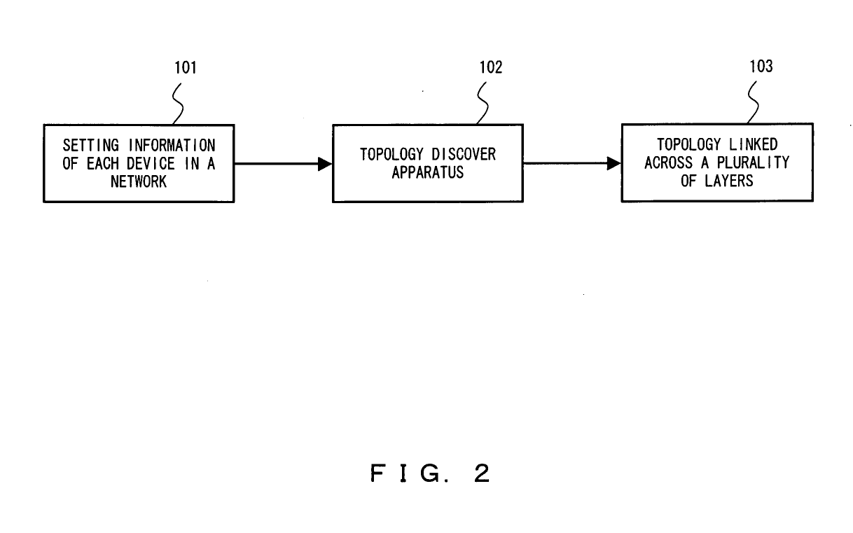

FIG. 2 shows the topology discover apparatus of the preferred embodiment. The topology discover apparatus 102 shown in FIG. 2 discovers topology, according to setting information 101 obtained from each device in a network to be managed, and outputs topology 103 linked across a plurality of layers. In this case, the topology discover apparatus 102 calculates both topology among respective devices in each of the plurality of layers and the linkage among the respective topology of the plurality of layers, according to the setting information 101. Thus, integrated topology taking into consideration linkage between layers can be calculated.

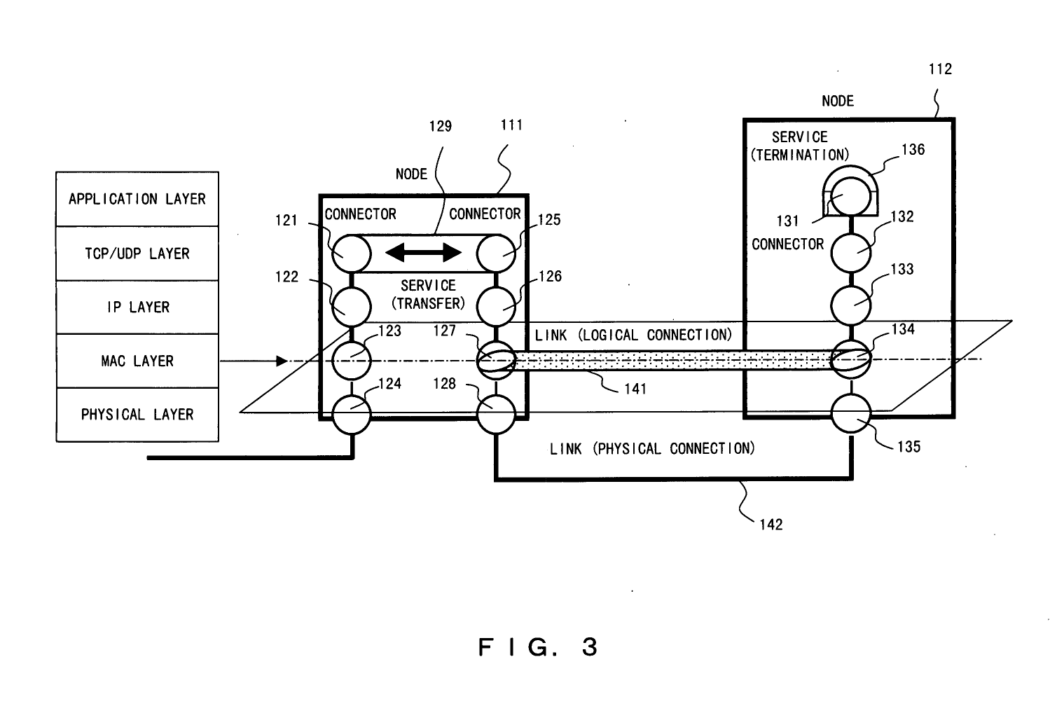

FIG. 3 shows the model of multi-layer topology. In this model, the data transmission/reception layers of a network are classified into a physical layer, a media access control (MAC) layer, an IP layer, a transmission control protocol (TCP)/user datagram protocol (UDP) layer and an application layer, from a lower-order layer toward a higher-order layer.

In each layer, physical/logical connection between devices is represented by a “link”, and the physical/logical interface of a device used for the “link” is represented by a “connector”. Then, a function to terminate communication and to transfer data between connectors in the devices is represented by a “service”. Each device is indicated by a “node”, and topology in each layer is indicated by three simple elements of “link”, “connector” and “service”.

The connector 131 of a node 112, shown in FIG. 3 is a connector for the application layer, and the connectors 121 and 125 of a node 111 and the connector 132 of a node 112 are connectors for the TCP/UDP layer. The service 136 of the node 112 is a service for terminating communication in the application layer, and the service 129 of the node 111 is a service for transferring data between the connectors of the TCP/UDP layer. The connectors 122 and 126 of the node 111 and the connector 133 of the node 112 are connectors for the IP layer.

The connector 123 and 127 of the node 111 and the connector 134 of the node 112 are connectors for the MAC layer, and the connectors 127 and 134 are logically connected by the link 141 of the MAC layer. The connectors 124 and 128 of the node 111 and the connector 135 of the node 112 are connectors for the physical layer, and the connectors 128 and 135 are physically connected by a link 142.

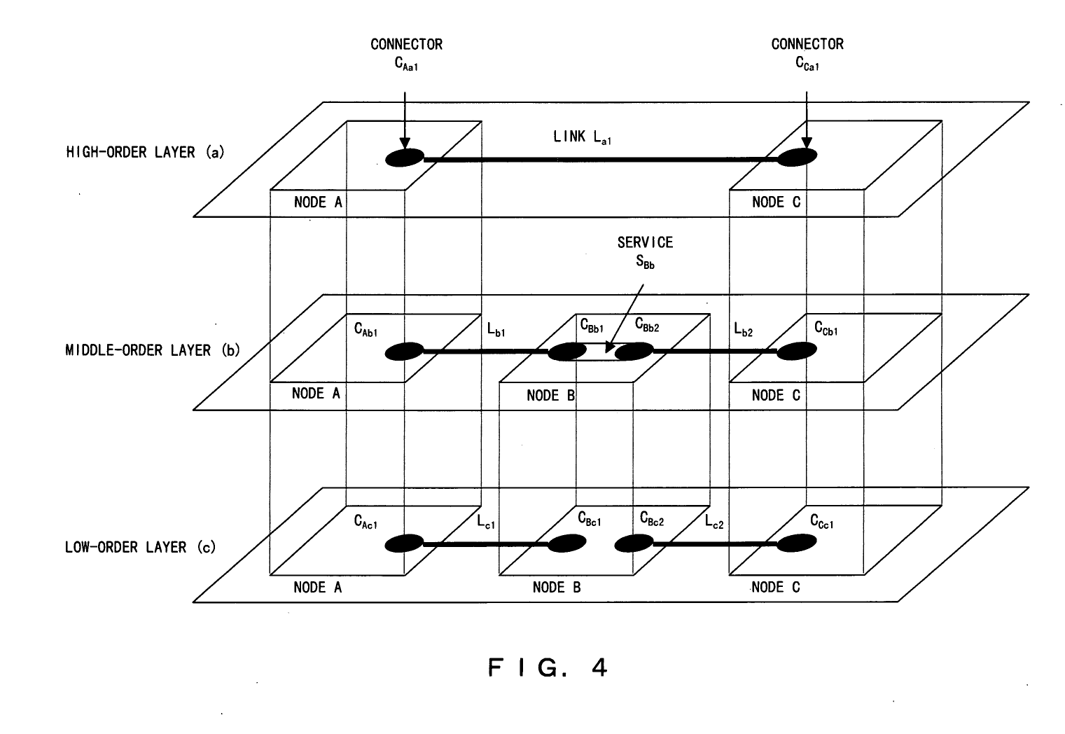

FIG. 4 shows linkage between low-order and high-order layers in such a model. A high-order layer (a), a middle-order layer (b) and a low-order layer (c) shown in FIG. 4 have nodes A and C, nodes A, B and C, and nodes A, B and C, respectively.

In the high-order (a), the connector C_{Aa1} of a node A and the connector C_{ca1} of a node C are connected by a link Lₐ₁. in the middle-order layer (b), the connector C_{Ab1} of node A and the connector C_{Bb1} of node B are connected by a link L_{b1}, and the connector C_{Bb2} of node B and the connector C_{cb1} of node C are connected by a link L_{b2}. There is a service S_{Bb} between the connectors C_{Bb1} and C_{Bb2} of node B.

In the low-order layer (C), the connector C_{Ac1} Of node A and connector C_{Bc1} of node B are connected by a link LC1, and the connector C_{Bc2} of node B and the connector C_{Cc1} of node C are connected by a link L_{c2}. In this case, the link Lₐ₁ of the high-order layer (a) is expressed by the links L_{b1} and L_{b2} of the middle-order layer (b).

As described above, a connection between devices in a specific layer can be expressed by the setting of a repeater device in the relevant layer and a set of connections of a lower-order layer. If the topology of the lower-order layer is given, respective topology can be sequentially calculated from a lower-order layer up to a higher-order layer utilizing this nature. Since in the topology calculated thus, data reachability in a lower-order layer is assured, a user can easily check that data is surely transmitted between devices.

FIG. 5 shows the configuration of the topology discover apparatus 102 shown in FIG. 2. The topology discover apparatus 102 shown in FIG. 5 is configured using an information processing device composed of, for example, a CPU (central processing unit) and memory, and comprises a topology discover unit 151.

The topology discover unit 151 performs a topology discovering process of each layer using physical connection information 152 about devices corresponding to the topology of a physical layer and setting information 153 of each device as input, and outputs topology 154 covering a plurality of layers. The setting information 153 and the topology 154 correspond to the setting information 101 and topology 103, respectively, shown in FIG. 2.

The setting information 153 is composed of device setting information about a plurality of devices composing a network, and the device setting information includes the setting information about the connector and service of each layer, based on the model shown in FIG. 3. The topology 154 is composed of an MAC layer topology 171, an IP layer topology 172, a TCP/UDP layer topology 173 and an application layer topology 174, and is outputted through a display or the like.

The topology discover unit 151 comprises an MAC layer topology discover unit 161, an IP layer topology discover unit 162, a TCP/UDP layer topology discover unit 163 and an application layer topology discover unit 164.

The MAC topology discover unit 161 performs the topology discovering process of the MAC layer, using physical connection information 152 and setting information 153 as input, and outputs the MAC layer topology 171. The IP layer topology discover unit 162 performs the topology discovering process of the IP layer, using the IP layer topology 172 and the setting information 153 as input, and outputs the IP layer topology 172.

The TCP/UDP layer topology discover unit 163 performs the topology discovering process of the TCP/UDP layer using the IP layer topology 172 and the setting information 153 as input, and outputs the TCP/UDP layer topology 173. The application layer topology discover unit 164 performs the topology discovering process of the application layer, using the TCP/UDP layer topology 173 and the setting information 153 as input, and outputs the application layer topology 174.

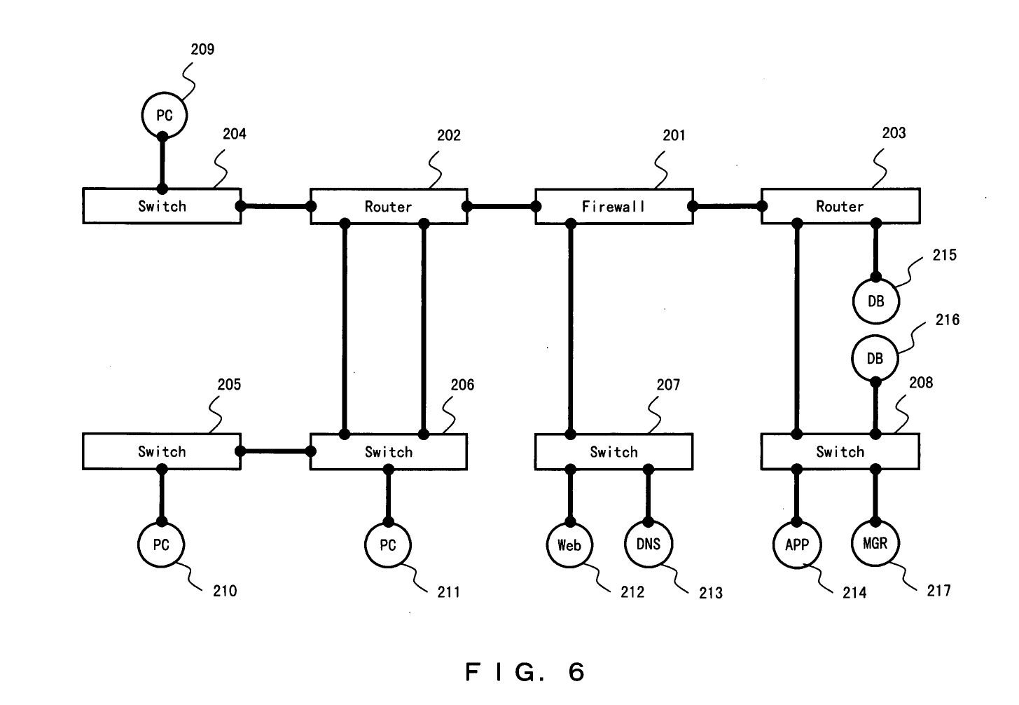

Next, a specific example of the input/output data of the topology discover apparatus is described with reference to FIGS. 6 through 10. In FIGS. 6 through 10, the black circle of each device and a thick line between black circles indicate a connector and a link, respectively.

FIG. 6 shows an example of the physical layer topology inputted as physical connection information 152. The network with topology shown in FIG. 6 comprises a firewall 201, routers 202 and 203, switches 204 through 208, personal computers 209 through 211, and servers 212 (Web), 213 (DNS), 214 (APP) 215 (DB) and 216 (DB).

The firewall 201 filters packets in the TCP/UDP layer, and the routers 202 and 203 transfer packets in the IP layer. Then, The switches 204 through 208 transfer packets in the MAC layer. The personal computers 209 through 211 are terminals using a network service, and the servers 212 is a terminal for providing a Web service in the application layer.

The server 213 provides a name resolution service in the IP layer, and the server 214 provides a middleware service in the application layer. Then, the servers 215 and 216 provide a database service in the application layer.

As shown in FIG. 6, a physical connection for linking devices is expressed as a link connecting the connectors in the physical layer of each device. The personal computer 209 is connected to the switch 204, and the switch 204 is connected to the router 202. The personal computers 210 and 211 are connected to the switches 205 and 206, respectively, and the switch 205 is connected to the switch 206. The switch 206 is connected to the router 202 by two links, and the router 202 is connected to the firewall 201.

The servers 212 and 213 are connected to the switch 207, and the switch 207 is connected to the firewall 201. The servers 214 and 216 are connected to the switch 208, and the switch 208 is connected to the router 203. The server 215 is connected to the router 203, and the router 203 is connected to the firewall 201.

The topology discover apparatus 217 (MGR) corresponds to the topology discover apparatus 102 shown in FIG. 5, and can be connected to an arbitrary position of the network. In this example, the topology discover apparatus 217 is connected to the switch 208. The topology discover apparatus 217 can collect setting information 153 from each device through the network, and obtain the topology of the network excluding the topology discover apparatus 217 by excluding the topology discover apparatus 217 from its information acquisition targets.

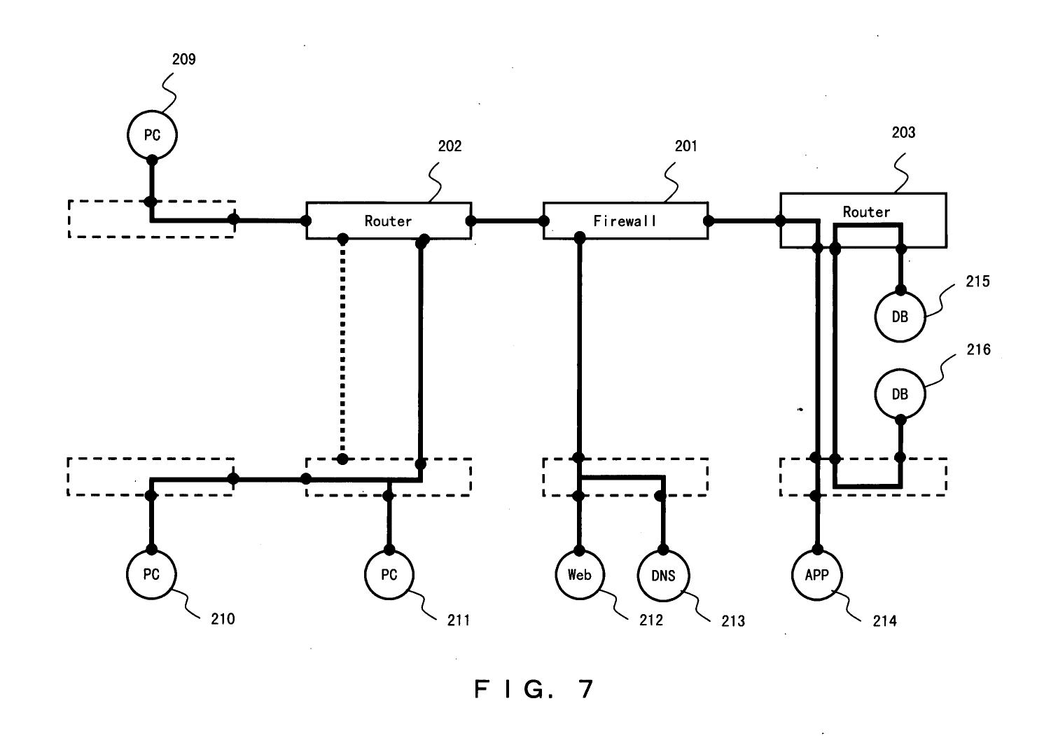

FIG. 7 shows an example of the MAC layer topology 171 outputted by the MAC layer topology discover unit 161. The MAC layer topology discover unit 161 groups a plurality of segments of physical connection information 152 according to bridging information, virtual local area network (VLAN) information and link aggregation information, included in the device setting information of the switches 204 through 208 in the setting information 153, in such away as to connect communicable connectors according to information about only the MAC layer, and outputs the grouped topology as MAC layer topology 171.

By referring to the bridging information of the switch, the combination of the physical layer connectors in which data can be transferred in the switch can be calculated, and by connecting those connectors, a plurality of physical connections can be integrated. By referring to the link aggregation information of a switch, links collected by the link aggregation of the physical layer links, in which a connector in the switch is a terminal point, can be integrated.

Furthermore, by referring to the VLAN information of a switch, the type of a VLAN assigned to the physical layer link in which a connector in the switch is a terminal point, can be calculated, and the link can be split into the same number of MAC layer links as the number of VLANs.

In the example shown in FIG. 7, the physical connection between the personal computer 209 and the switch 204, and the physical connection between the switch 204 and the router 202 are integrated according to the bridging information of the switch 204 and is expressed by one link.

Similarly, physical connections ranging from the personal computers 210 and 211 up to the router 202 are integrated according to the bridging information of the switches 205 and 206 and the link aggregation information of the switch 206. More particularly, the physical connections between the router 202 and switch 206, expressed by two links in the physical layer are integrated according to link aggregation information, and is expressed by a one link. The physical connection between the router 203 and the switch 208 is split into two links according to the VLAN information of the switch 208.

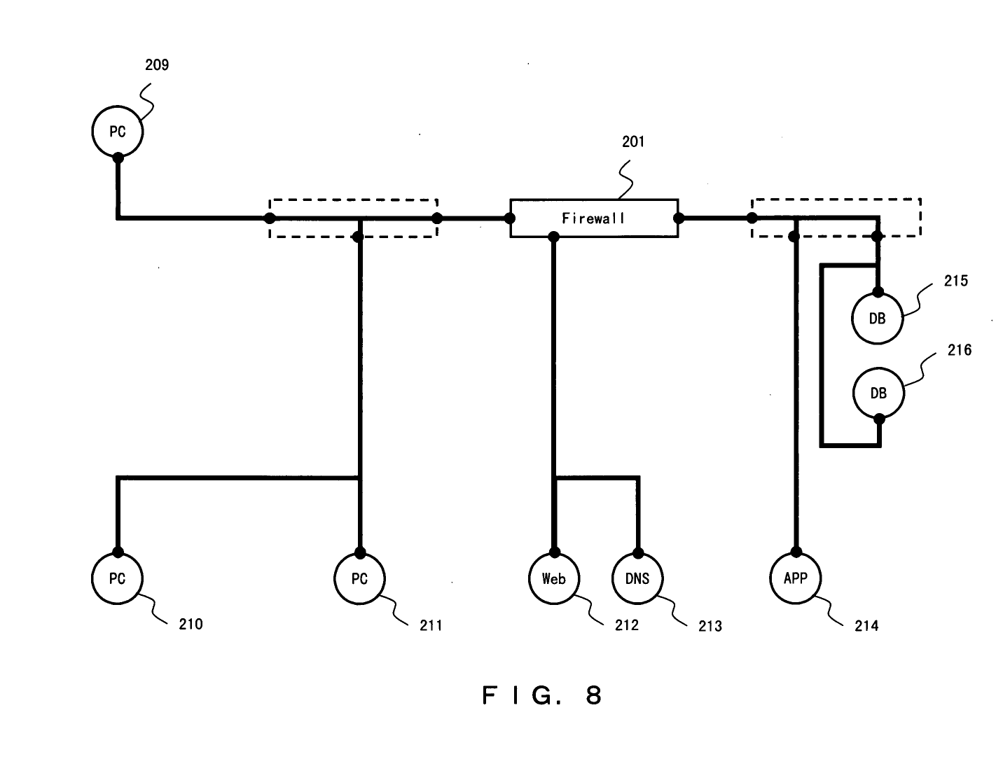

FIG. 8 shows an example of the IP layer topology 172 outputted by the IP layer topology discover unit 162. The IP layer topology discover unit 162 groups a plurality of segments of the topology 171 in such a way as to connect communicable connectors according to information about the IP layer, according to routing information included in the device setting information of the routers 202 and 203 in the setting information 153, and outputs the grouped topology as IP layer topology 172.

By referring to the routing information of a router, the combination of the MAC layer connectors in which data can be transferred in the router can be calculated, and by connecting those connectors, a plurality of logical connections can be integrated.

In the example shown in FIG. 8, the logical connection between the personal computer 209 and the router 202, the logical connection between the personal computers 210 and 211 and the router 202 and the logical connection between the router 202 and the firewall 201 are integrated according to the routing information of the router 202. Similarly, the logical connection between the server 214 and the firewall 201 and the logical connection between the servers 215 and 216 are integrated according to the routing information of the router 203.

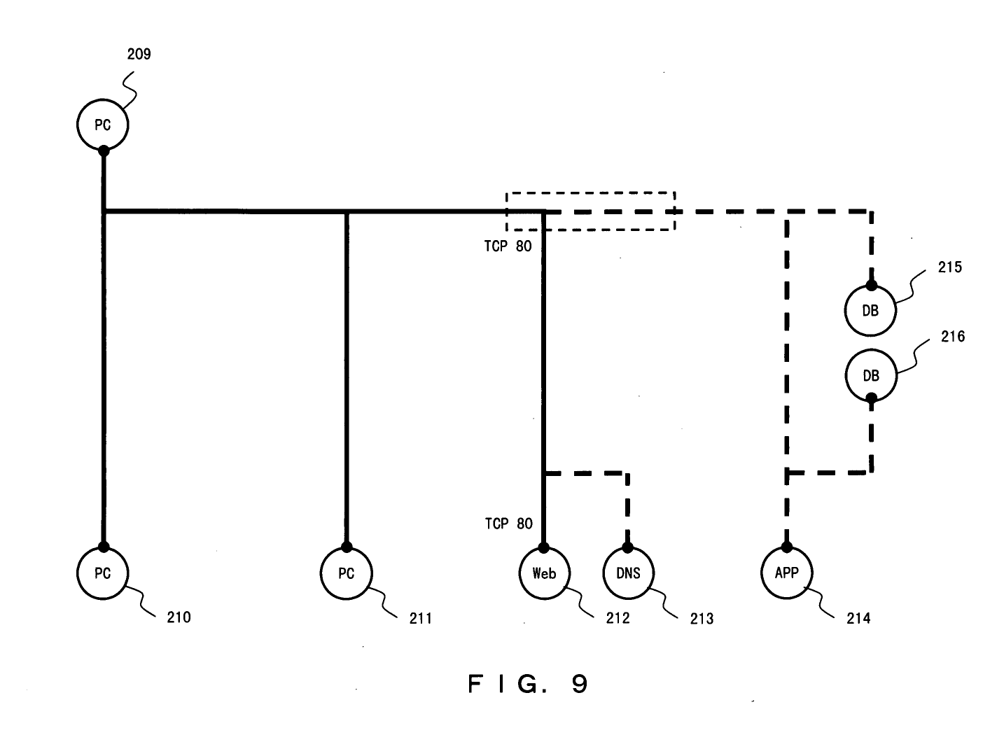

FIG. 9 shows an example of the TCP/UDP layer topology 173 outputted by the TCP/UDP layer topology discover unit 163. The TCP/UDP layer topology discover unit 163 groups a plurality of segments of IP layer topology 172, according to packet filtering information included in the device setting information of the firewall 201 in setting information 153, and outputs the grouped topology as TCP/UDP layer topology 173.

By referring to the packet filtering information of a firewall, it can be determined whether data can be transferred between IP layer connectors, and topology for connecting the transferable connectors can be calculated. However, since a device for providing a service in the TCP/UDP layer behaves differently for each port number, TCP/UDP layer topology must be calculated for each port number.

In FIG. 9, topology is calculated for the port number of TCP 80 according to the packet filtering information of the firewall 201. The topology of TCP 80 indicates the logical connection between the personal computers 209, 210 and 211 and the server 212. As to other port numbers, topology can be calculated similarly.

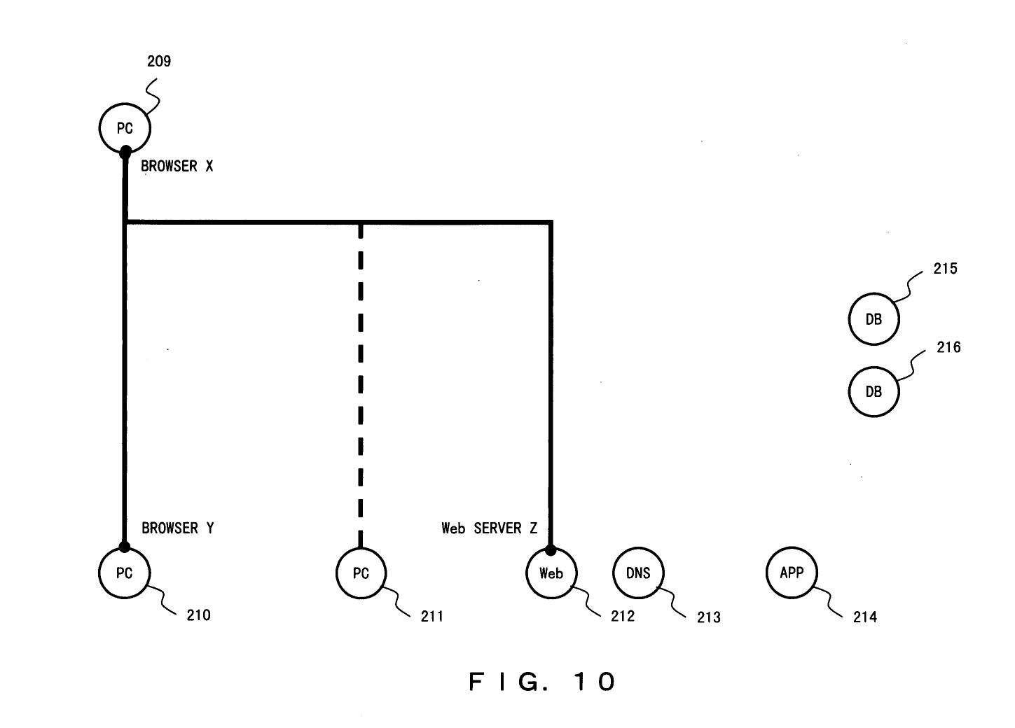

FIG. 10 shows an example of the application layer topology 174 outputted by the application layer topology discover unit 164. The application layer topology discover unit 164 links TCP/UDP layer topology 173 with the identification information of an application, according to application information included in the device setting information of the servers 212 through 216 in setting information 153, and outputs the linked topology as application layer topology 174.

By referring to the application information of a server, it can be determined whether data can be transferred between TCP/UDP layer connectors by the application operating in the server, and topology for connecting transferable connectors can be calculated. However, application layer topology must be calculated for each service provided by an operating server.

In FIG. 10, topology is calculated for a Web service according to the application information of the server 212. The topology of this Web service indicates the logical connection between the personal computers 209, 210 and 211 and the server 212. In this example, the server 212 is provided with a Web server Z, which is an application program for providing a Web service, and the personal computers 209 and 210 is provided with browsers X and Y, which are application programs by which a Web service can be used. Since the personal computer 211 is provided with no browser, the computer is excluded from this logical connection. As to other services, topology can be calculated similarly.

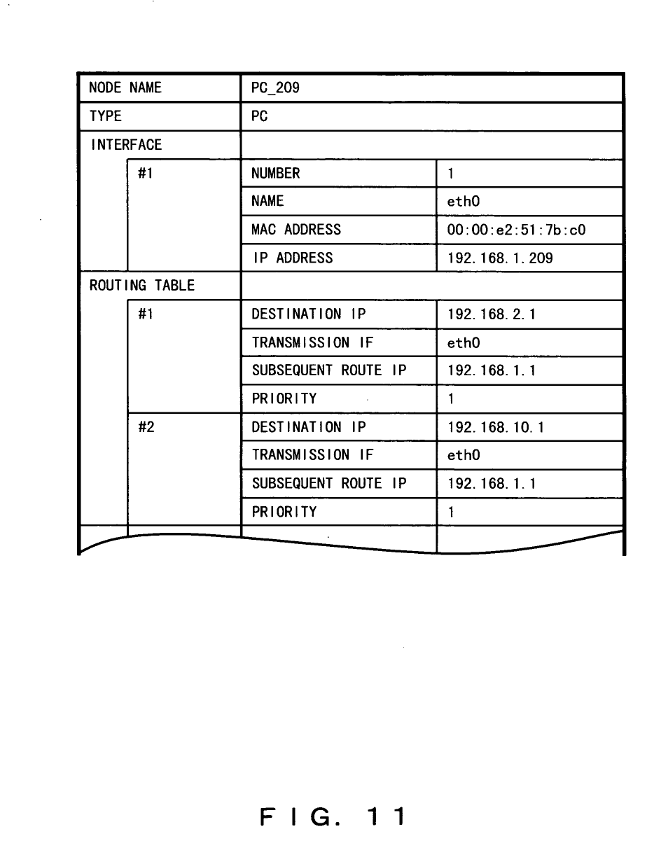

FIG. 11 shows an example of the device setting information of each device, included in setting information 153. The device setting information shown in FIG. 11 is that of the personal computer 209, and includes a node name, a type, an interface and a routing table. The node name is the identification information of each device, and the type is the type of the device. The interface is information about of a communication interface provided for the device, and the routing table is information about a route used to communicate by each interface.

The personal computer 209 is provided with one interface, and the interface information includes its number, its name, its MAC address and its IP address. The routing table registers a destination IP address, the name of a transmitting interface, a subsequent route IP address and priority for each entry.

Besides, the device setting information about a switch includes bridging information, VLAN information and link aggregation information, and the device setting information of a router includes routing information. Then, the device setting information of a firewall includes packet filtering information, and the device setting information of a server includes application information.

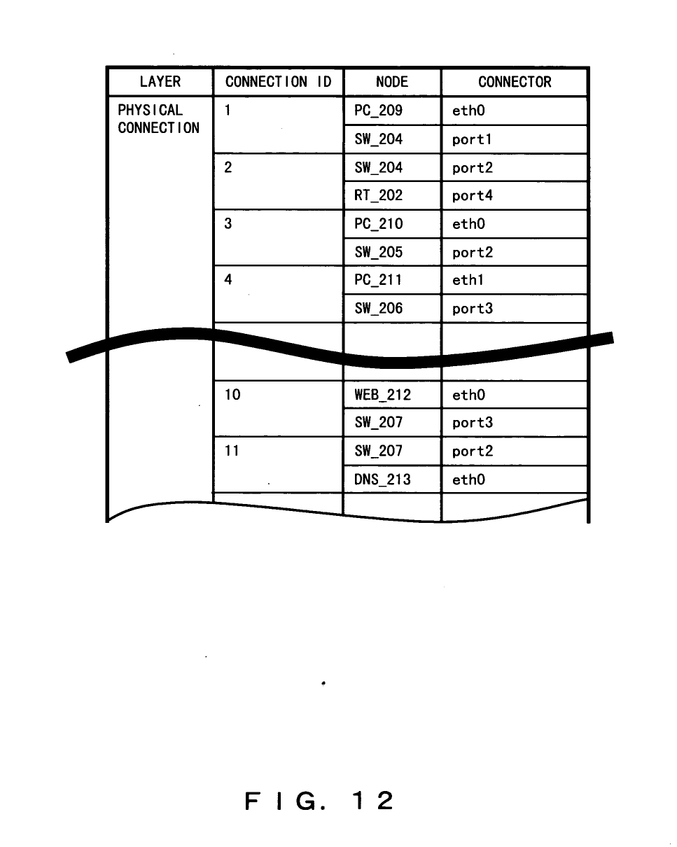

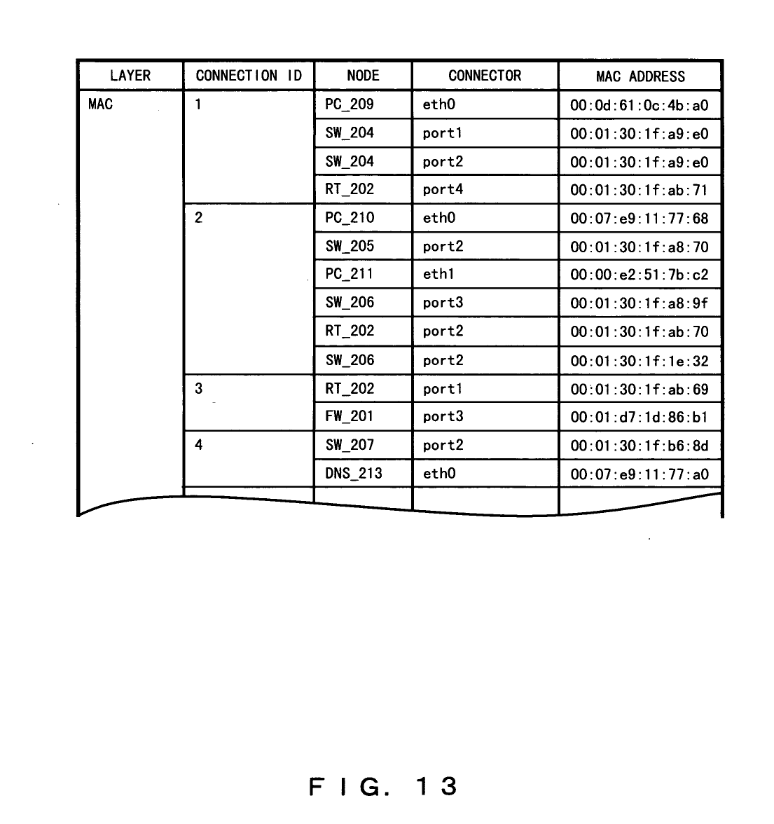

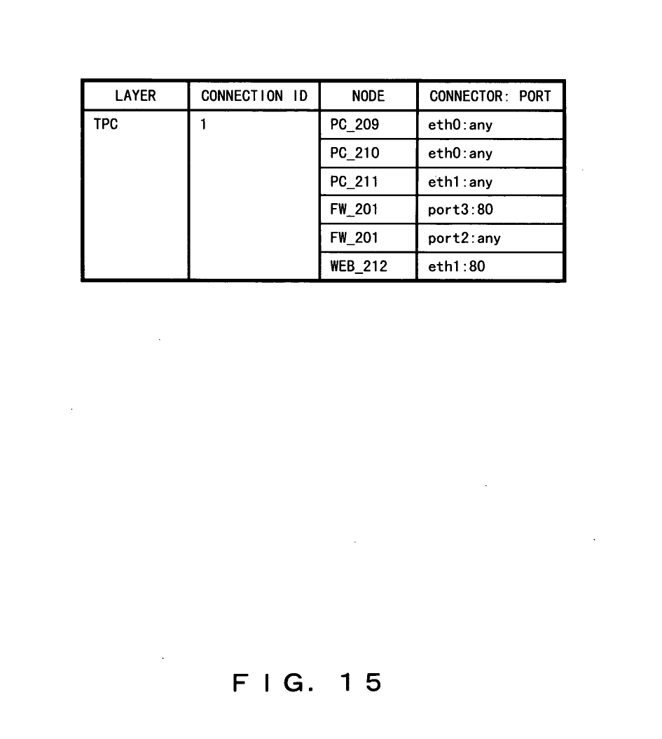

FIGS. 12, 13, 14, 15 and 16 show the topology data of respective layers shown in FIGS. 6, 7, 8, 9 and 10. The topology data of the physical layer shown in FIG. 12 is the input data of the topology discover apparatus 102, and the topology data of respective layers shown in FIGS. 13 through 16 are the output data of the topology discover apparatus 102.

The topology data of each layer describes the names of connected nodes for each identification information (connection ID) of the physical/logical connection in the layer, and the topology data shown in FIGS. 12 through 15 describes the names of the connectors (interfaces) included in the connection for each connection ID.

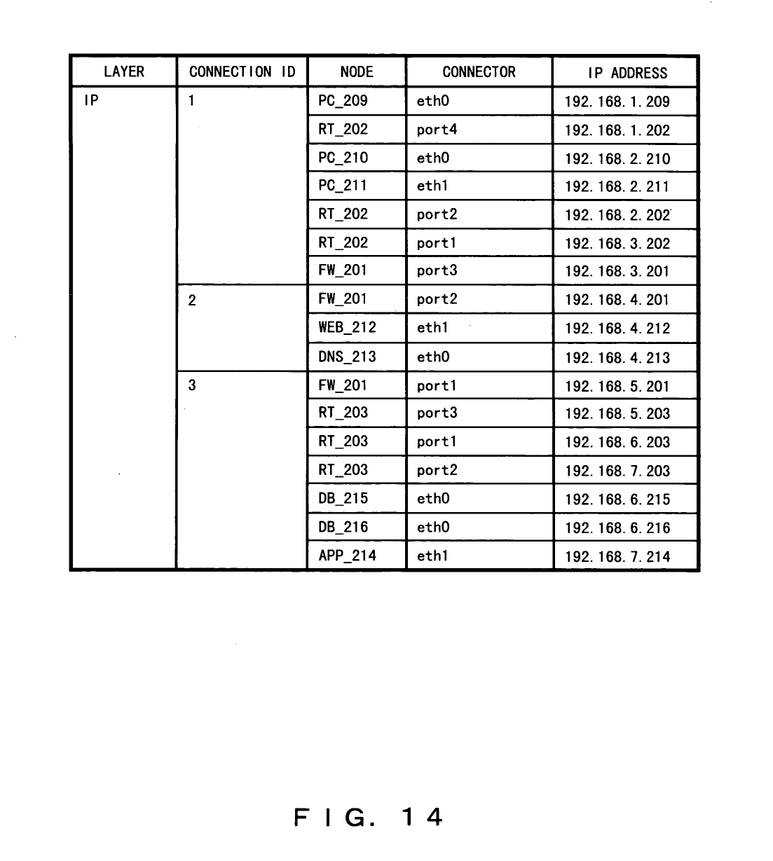

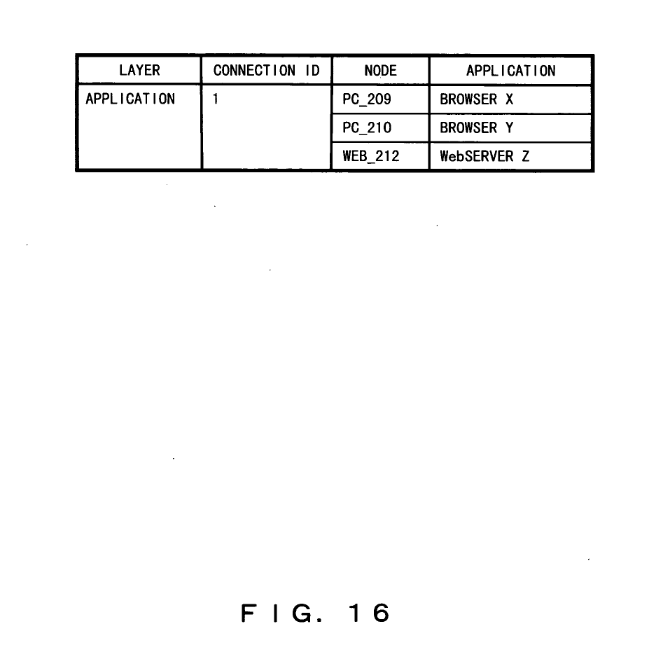

Furthermore, the topology data of the MAC layer shown in FIG. 13 describes the MAC address of each connector, and the topology data of the IP layer shown in FIG. 14 describes the IP address of each connector. Then, the topology data of the TCP/UDP layer describes designation of the port number of each connector, and the topology data of the application layer shown in FIG. 16 describes the identification information of an application program operating in each node.

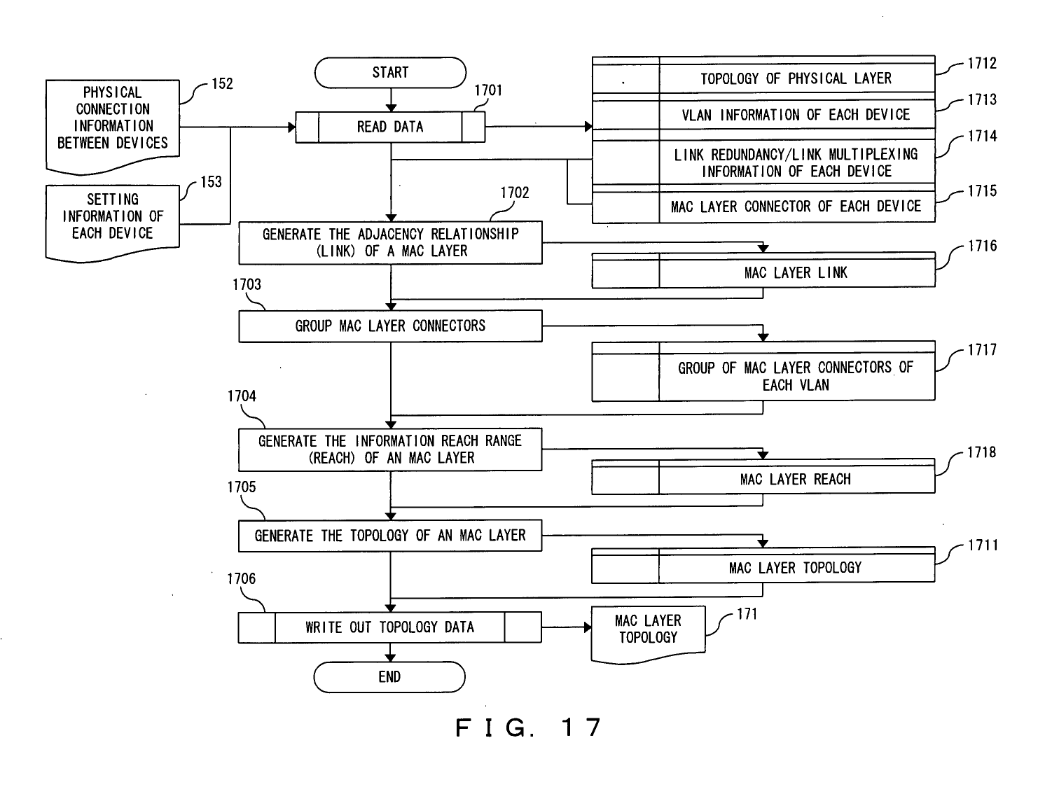

Next, the topology discovering process of the topology discover apparatus 102 shown in FIG. 5 is described in detail with reference to FIGS. 17 through 20.

FIG. 17 is a flowchart showing the MAC layer topology discovering process of the MAC layer topology discover unit 161. The MAC layer topology discover unit 161 firstly reads physical connection information 152 from an external storage device and stores the information in memory as physical layer topology 1711. Then, the MAC layer topology discover unit 161 reads setting information 153 to extract the VLAN information 1712 of each device, the link redundancy/link multiplexing information 1713 of each device and the MAC layer connector 1714 of each device included in the information, and stores them in the memory (step 1701).

The link redundancy/link multiplexing information 1713 of each device and the MAC layer connector 1714 of each device correspond to the above-mentioned link aggregation information and bridging information, respectively.

Then, a plurality of segments of physical layer topology from the link redundancy/link multiplexing information 1713 is grouped to generate MAC layer adjacency relationship (link) 1715, and the adjacency relationship 1715 is stored (step 1702). Then, MAC layer connectors belonging to each VLAN are grouped using VLAN information 1712 to generate the group of MAC layer connectors 1716 of each VLAN and the group of connectors 1716 is stored in the memory (step 1703).

Then, links are collected for each group of MAC layer connectors to generate the information reach range (reach) 1717 of the MAC layer and the reach 1717 is stored in the memory (step 1704). Then, the MAC layer link and the MAC layer reach are combined to generate MAC layer topology 1718 and the topology 1718 is stored in the memory (step 1705). Then, the MAC layer topology 1718 is written into an external storage device as MAC layer topology 171 (step 1706).

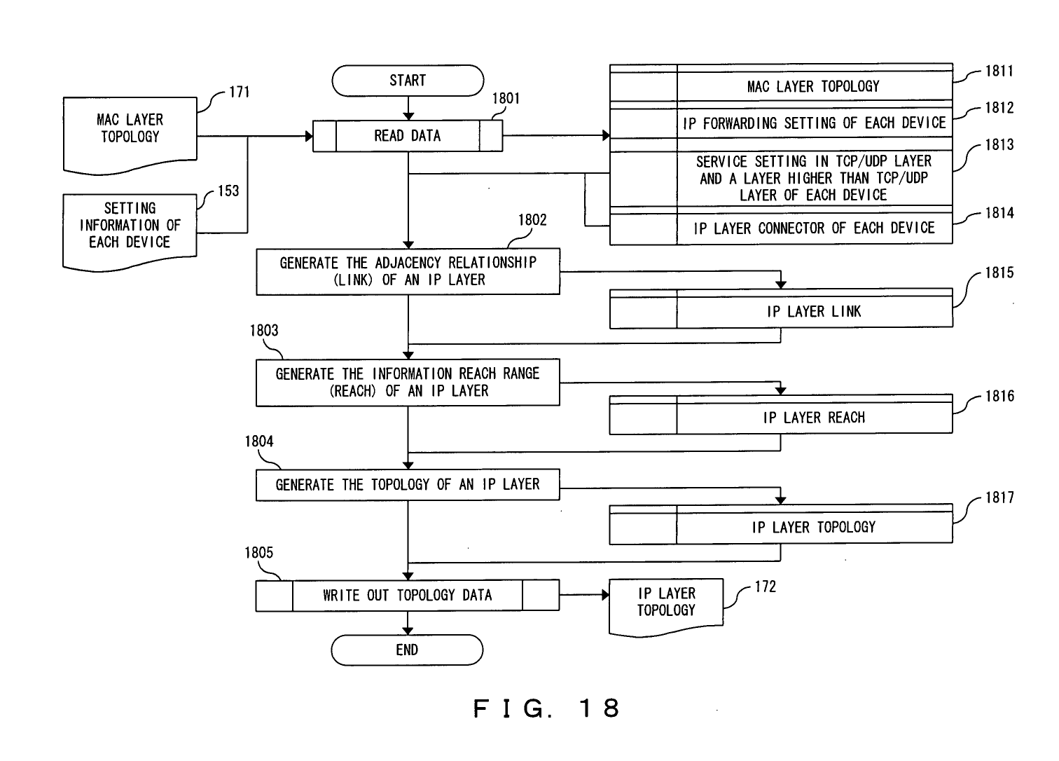

FIG. 18 is a flowchart showing the IP layer topology discovering process of the IP layer topology discover unit 162. The IP layer topology discover unit 162 firstly reads MAC layer topology 171 from an external storage device and stores the topology in the memory as the MAC layer topology 1811. Then, the IP layer topology discover unit 162 reads setting information 153 to extract the IP forwarding setting 1812, setting 1813 of a service in the TCP/UDP layer and a layer higher than the TCP/UDP layer and the IP layer connector 1814 of each device included in the information, and stores them in the memory (step 1801). The IP forwarding setting 1812 corresponds to the above-mentioned routing information.

Then, the IP layer topology discover unit 162 calculates a sub-net to which each connector belongs, based on the IP address of the IP layer connector 1814 and groups connectors for each sub-net to generate IP layer adjacency relationship (link) 1815, and stores the link in the memory (step 1802). Then, the IP layer topology discover unit 162 groups links to which devices that perform IP forwarding and do not provide service in the TCP/UDP layer belong, to generate IP layer reach 1816 and stores the reach in the memory (step 1803). The device that performs IP forwarding is a device that relays data in the IP layer.

Then, the IP layer topology discover unit 162 combines the IP layer link with the IP layer reach to generate IP layer topology 1817, and stores the topology in the memory (step 1804). Then, the IP layer topology discover unit 162 writes the IP layer topology 1817 into the external storage device as IP layer topology 172 (step 1805).

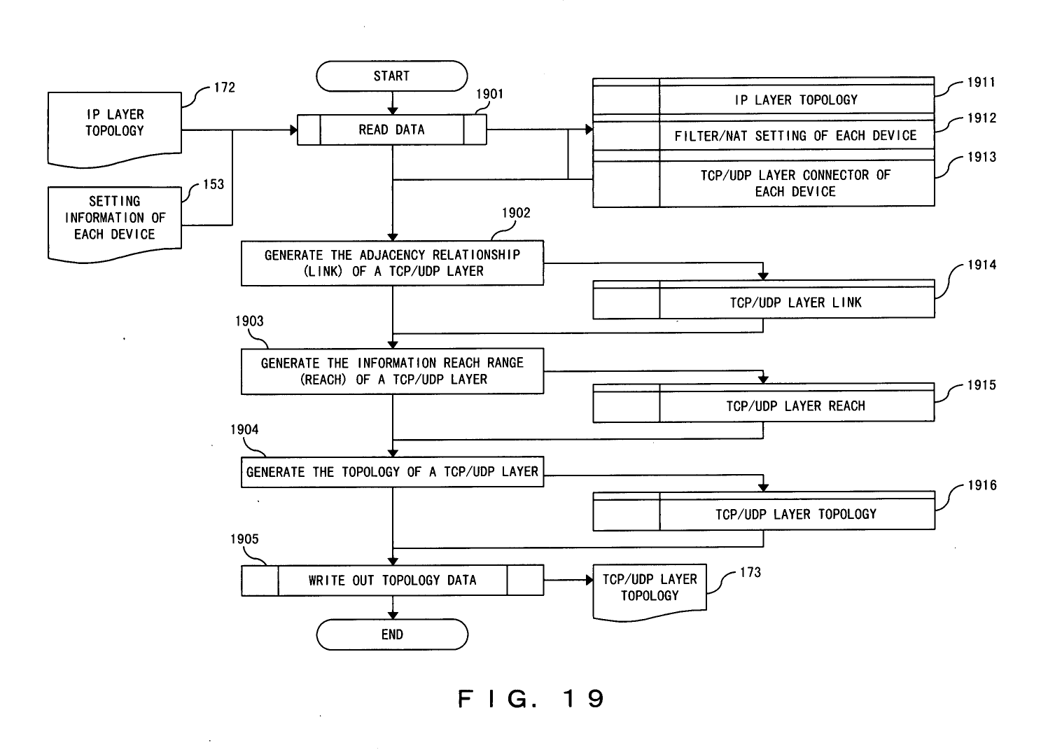

FIG. 19 is a flowchart showing the TCP/UDP layer topology discover process of the TCP/UDP layer topology discover unit 163. The TCP/UDP layer topology discover unit 163 firstly reads IP layer topology 172 from an external storage device and stores the topology in memory as IP layer topology 1911. Then, the TCP/UDP layer topology discover unit 163 reads setting information 153 to extract both the filter/network address translation (NAT) setting 1912 and the TCP/UDP layer connector 1913 of each device included in the information, and stores them in the memory (step 1901). The filter/NAT setting 1912 corresponds to the above-mentioned packet filtering information.

Then, the TCP/UDP layer topology discover unit 163 collects communicable TCP/UDP layer connectors of all devices belonging to each reach of the IP layer topology 1911 to generate TCP/UDP layer adjacency relationship (link) 1914, and stores the link in the memory (step 1902). Then, the TCP/UDP layer topology discover unit 163 groups TCP/UDP layer links connected by a filter for each setting rule of a device providing a filter/NAT service to generate the reach 1915 of the TCP/UDP layer, and stores the reach in the memory (step 1903).

Then, the TCP/UDP layer topology discover unit 163 combines the link of the TCP/UDP layer with the reach of the TCP/UDP layer to generate TCP/UDP layer topology 1916, and stores the topology in the memory (step 1904). Then, the TCP/UDP layer topology discover unit 163 writes the TCP/UDP layer topology 1916 into the external storage device as TCP/UDP layer topology 173 (step 1905).

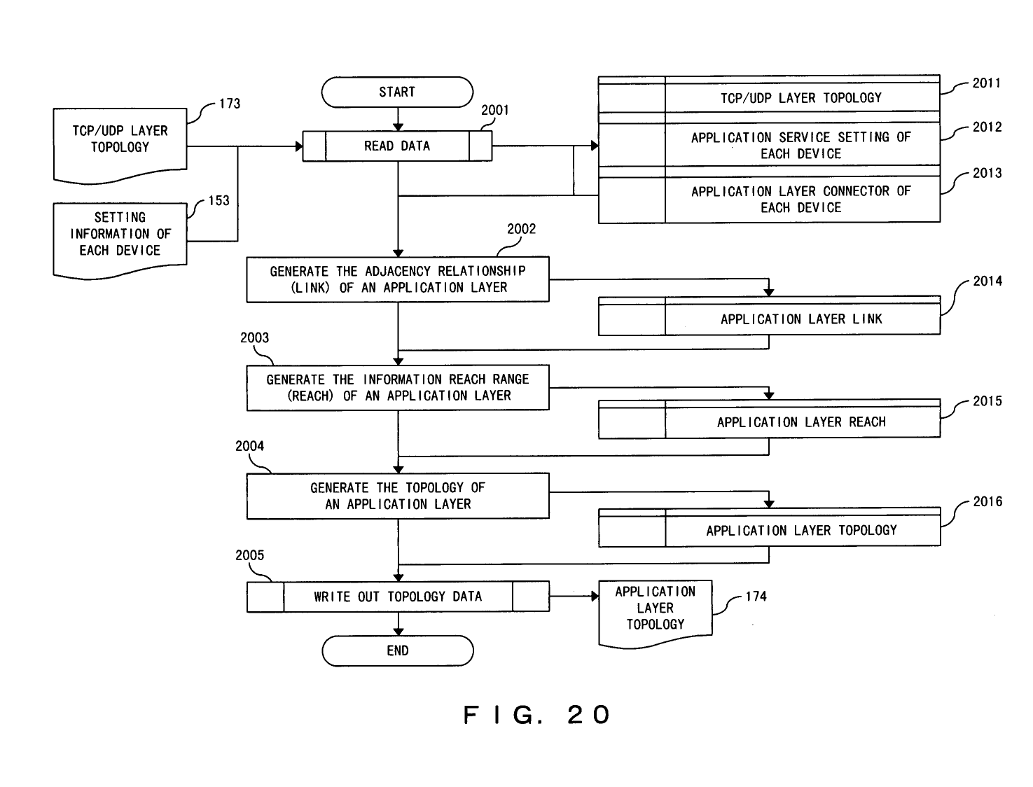

FIG. 20 is a flowchart showing the application layer topology discovering process of the application layer topology discover unit 164. The application layer topology discover unit 164 firstly reads TCP/UDP layer topology 171 from an external storage device and stores the topology in memory as TCP/UDP layer topology 2011. Then, the application layer topology discover unit 164 reads setting information 153 to extract the setting 2012 of an application service and the application layer connector 2013 of each device, included in the information, and stores them in the memory (step 2001). The setting 2012 of an application service corresponds to the above-mentioned application information.

Then, the application layer topology discover unit 164 collects the communicable application layer connectors of all devices belonging to each reach of the TCP/UDP layer topology 2011 to generate application layer adjacency relationship (link) 2014, and stores the link in the memory (step 2002). Then, the application layer topology discover unit 164 groups application layer links connected by a service for each setting rule of a device providing an application service to generate application reach 2015, and stores the reach in the memory (step 2003).

Then, the application layer topology discover unit 164 combines the application layer link with the application layer reach to generate application topology 2016, and stores the topology in the memory (step 2004). Then, the application layer topology discover unit 164 writes the application layer topology 2016 into the external storage device as application layer topology 174 (step 2005).

According to such a topology discovering process, information reach range is sequentially generated starting from a lower-order layer, that is, from the physical layer toward the application layer. Therefore, each obtained layer topology is supported by the data reachability of a lower-order layer.

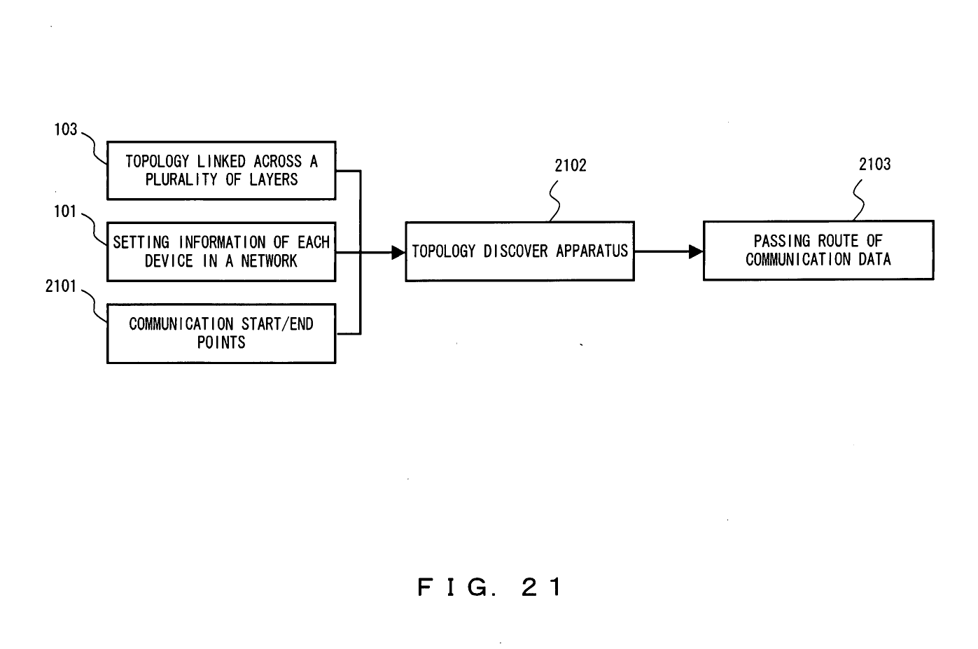

Next, the topology discover apparatus for discovering the passing route of communication data is described. FIG. 21 shows such a second topology discover apparatus. The topology discover apparatus 2102 shown in FIG. 21 searches for and outputs the passing route of communication data 2103, based on topology 103 linked across a plurality of layers, setting information 101 obtained from each device in a network and the start/end points 2101 of communication.

In this case, the topology discover apparatus 2102 determines the possibility of data transmission by designated application between arbitrary two points in the network. If data can be transmitted between them, the topology discover apparatus 2102 determines the passing route of the data and manages the data reachability of the network. Thus, in the application, devices through which arbitrary service data passes and its passing order can be calculated, and accordingly its passing route and devices used by other services can be calculated.

FIG. 22 shows the configuration of the second topology discover apparatus 2102 shown in FIG. 21. The topology discover apparatus 2102 is, for example, configured using an information processing device provided with a CPU and memory, and can be obtained by adding a route discover unit 2201 to the topology discover apparatus 102 shown in FIG. 5. The route discover unit 2201 comprises a subsequent route determination unit 2211 and a dynamic information calculation unit 2212, and stores search target information 2213 and subsequent search target information 2214 in the memory.

The route discover unit 2201 performs a route discovering process, using the setting information 153 of each device, topology 2202 covering a plurality of layers and search conditions 2203 as input, and outputs a data passing route 2204 through a display or the like.

The topology 2202 can be obtained by adding a physical layer topology 2241 corresponding to the physical connection information 152 to the topology 154 shown in FIG. 5. The search conditions 2203 includes information about two points 2251 in a network, which are the start/end points of communication, and information about a service type 2252. The two intra-network points 2251 and data passing route 2204 correspond to the communication start/end points 2101 and communication data passing route 2103, respectively. The two intra-network points 2251 are node names, IP addresses or the like, designated by a user.

The search target information 2213 includes information about the current connector 2221 and the previous connector 2222, and the subsequent search target information includes information about a higher-order layer connector 2231 and a lower-order layer connector 2232. The data passing route 2204 includes information about connectors 2241-1 through 2241-n through which data passed.

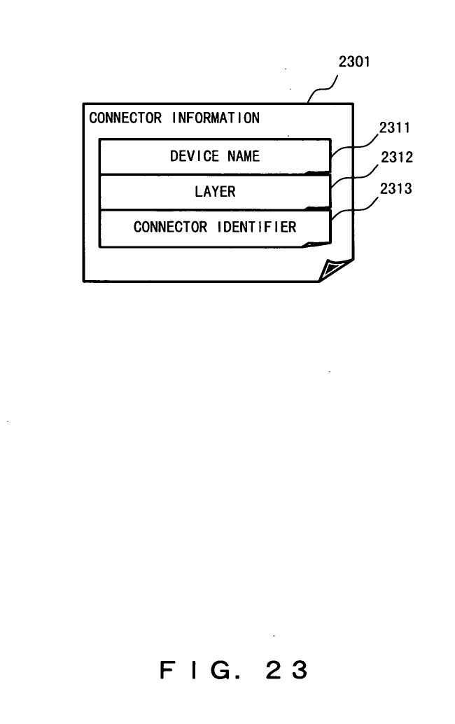

FIG. 23 shows the data structure of each of the current connector 2221, the previous connector 2222, a higher-order layer connector 2231, a lower-order layer connector 2232 and connectors 2241-1 through 2241-n through which data passed. The connector information 2301 shown in FIG. 23 includes a device name 2311 to which the corresponding connector belongs, layer identification information 2312 and a connector identifier 2313 for uniquely identifying a connector in the same layer.

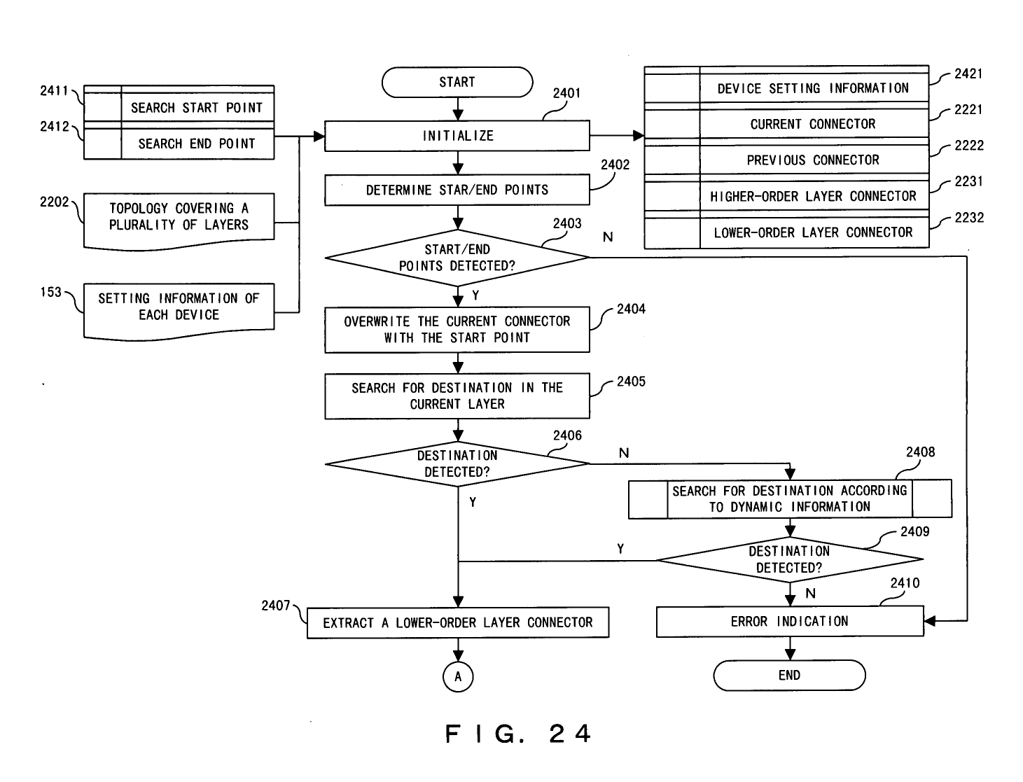

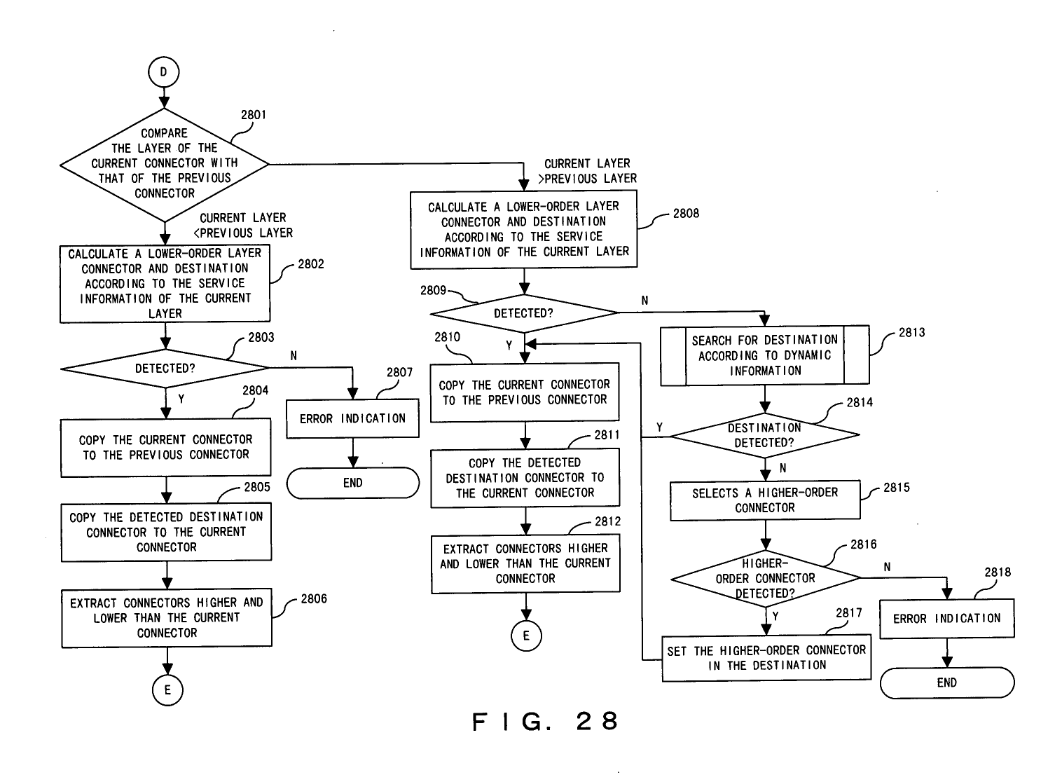

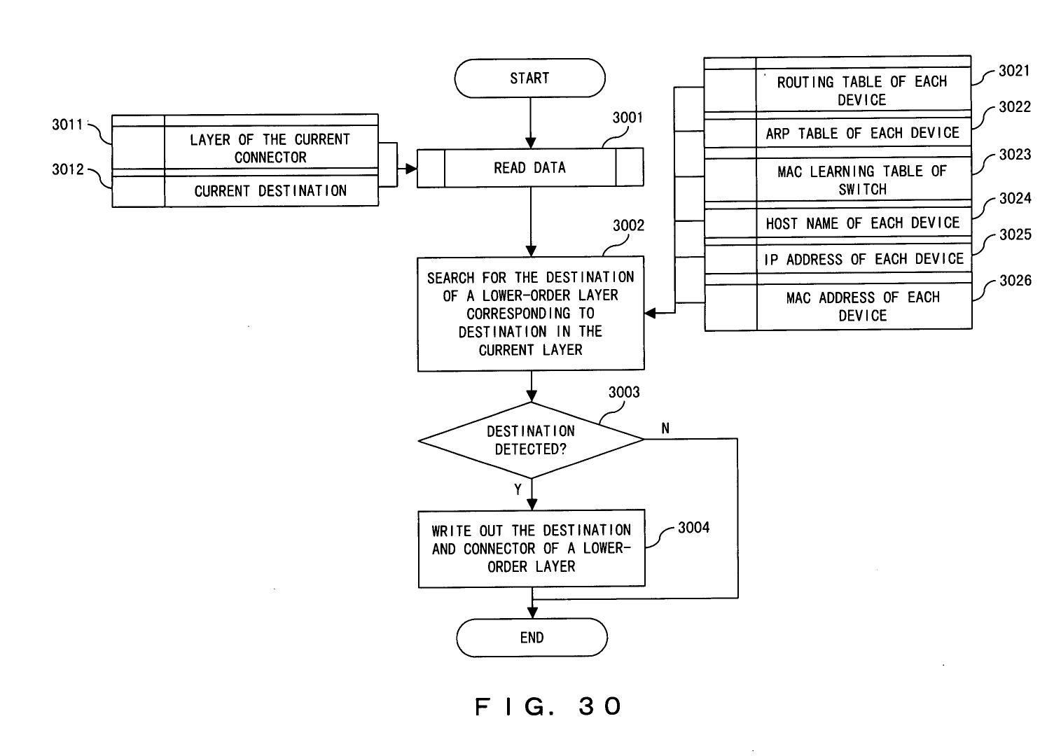

FIGS. 24 through 29 are flowcharts showing the route discovering process of the subsequent route determination unit 2211. FIG. 30 is a flowchart showing the destination searching process of the dynamic information calculation unit 2212 in step 2408 of FIG. 24 and step 2813 of FIG. 28. In the route discovering process, the data passing route of an arbitrary service between two points is calculated.

When search conditions 2203 are inputted, as shown in FIG. 24, the information of two intra-network points 2251 are stored in the memory as a search start point 2411 (communication start point) and a search end point 2412 (communication end point).

The subsequent route determination unit 2211 firstly performs an initialization process referring to the search start point 2411, the search end point 2412, topology 2202 and setting information 153 (step 2401 shown in FIG. 24). Then, the subsequent route determination unit 2211 performs a start/end point determining process (step 2402) and checks whether both the start/end points are obtained (step 2403).

In the initialization process of step 2401, the setting information 153 is stored in the memory as device setting information 2421, and the current connector 2221, the previous connector 2222, the higher-order layer connector 2231 and the lower-order layer connector 2232 are made empty. In the start/endpoint determining process of step 2402, device setting in formation 2421 is referred to, and start-point and end-point connectors corresponding to the search start and end points, respectively, are searched for according to the setting information about a service designated by the service type 2252.

If the start and end points are not obtained, it is regarded that the search failed and the error is indicated (step 2410). Then, the process is terminated. If the start and endpoints are obtained, the start-point connector is registered in the current connector (step 2404).

Then, the device setting information 2421 is referred to, and destination needed when the start-point connector communicates with the end-point connector, is searched for (step 2405). Then, it is determined whether the destination could be obtained (step 2406). If the destination could be obtained, by referring to the device setting information 2421, a connector in a layer lower than the current connector 2221 is extracted and is registered in the lower-order layer connector 2232 (step 2407).

If in step 2406, the destination is not obtained or if it is necessary to dynamically obtain the destination by a name resolution method or the like (if it is necessary to make an inquiry to another device, etc.), the subsequent route determination unit 2211 asks the dynamic information calculation unit 2212 to search for the destination according to dynamic information (step 2408). The dynamic information calculation unit 2212 searches for the destination in the setting information of another device of the network and transfers the obtained destination to the subsequent route determination unit 2211.

The subsequent route determination unit 2211 checks whether the destination could be obtained (step 2409). If the destination could not be obtained, the process in step 2410 is performed, and the process is terminated. If in step 2409, the destination could be obtained, the process in step 2407 and after is performed.

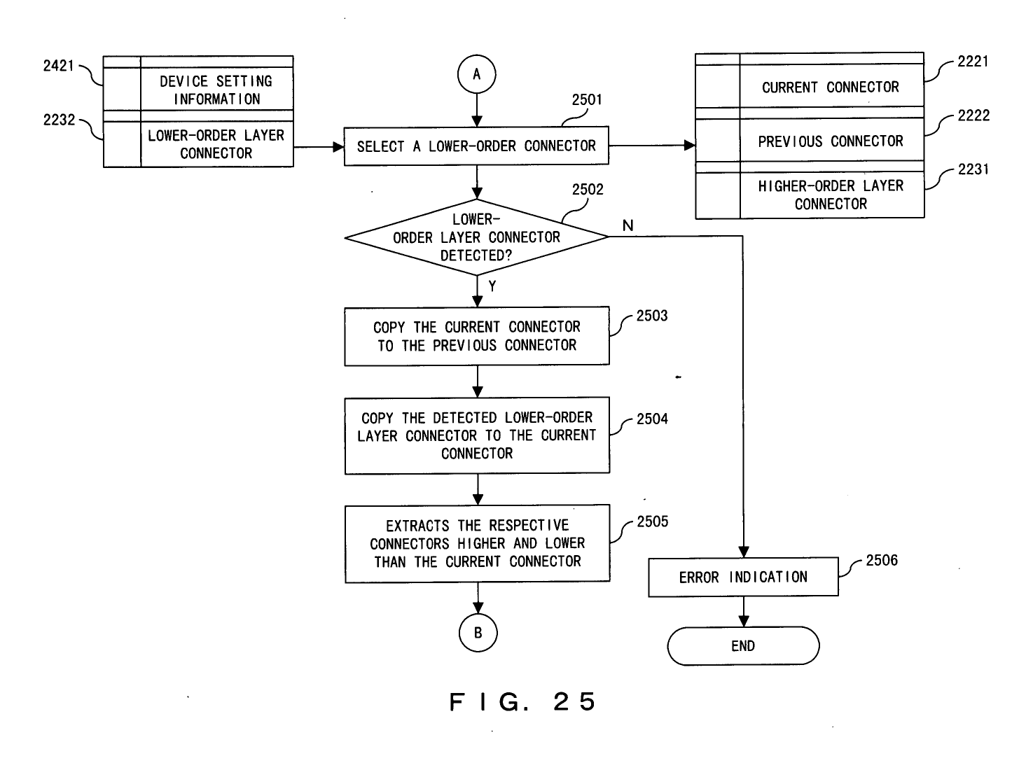

Then, a connector to be used to transmit data is selected from the lower-order layer connectors 2232, according to the obtained destination (step 2501 in FIG. 25), and it is determined whether the connector was selected (step 2502). If the connector could not be selected, the error is indicated (step 2506), and the process is terminated.

In the lower-order connector selecting process of step 2501, the device setting information 2421 is referred to and information for linking the current layer with a lower-order layer is used. For example, if the current connector 2221 is located in the IP layer and the destination IP address is known, a lower-order layer connector is selected in the following procedure, and destination in a lower-order layer is determined.
(1) A routing table corresponding to the current layer of a device having the current connector 2221, as shown in FIG. 11 is referred to according to the device setting information 2421. Then, both the subsequent route IP address of an entry having a destination IP address that coincides with the current destination and the name of a transmitting interface are obtained. The obtained transmitting interface becomes a lower-order layer connector.
(2) An interface having an IP address corresponding to a subsequent route IP address is searched for in the device setting information 2421, and the MAC address of the corresponding interface is obtained. The obtained MAC address is destination in the lower-order layer.

If a lower-order layer connector is selected, the current connector 2221 is copied to the previous connector 2222 (step 2503), and the selected lower-order layer connector is copied to the current connector 2221 (step 2504). Then, by referring to the device setting information 2421, a connector in a layer higher than the current connector 2221 is extracted and is registered in the higher-order layer connector 2231. Simultaneously, a connector in a layer lower than the current connector 2221 is extracted and is registered in the lower-order layer connector 2232 (step 2505).

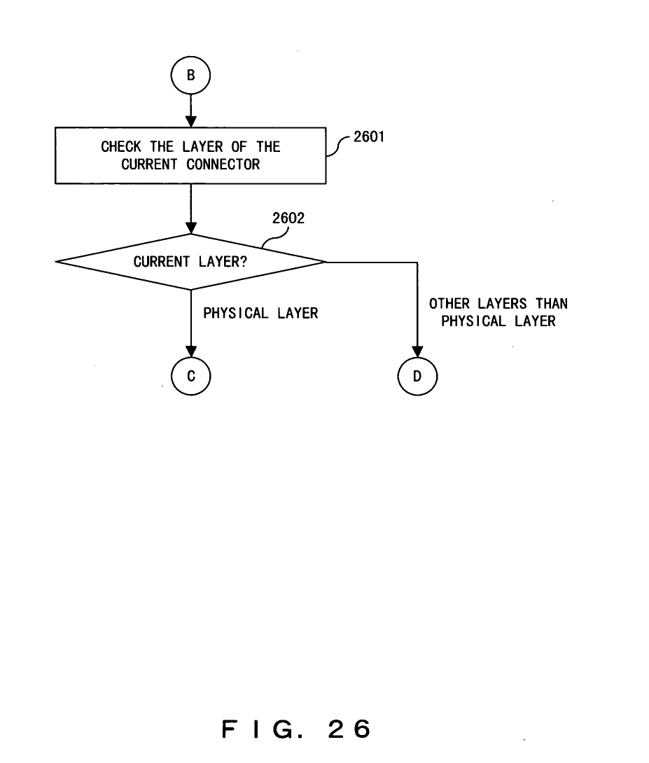

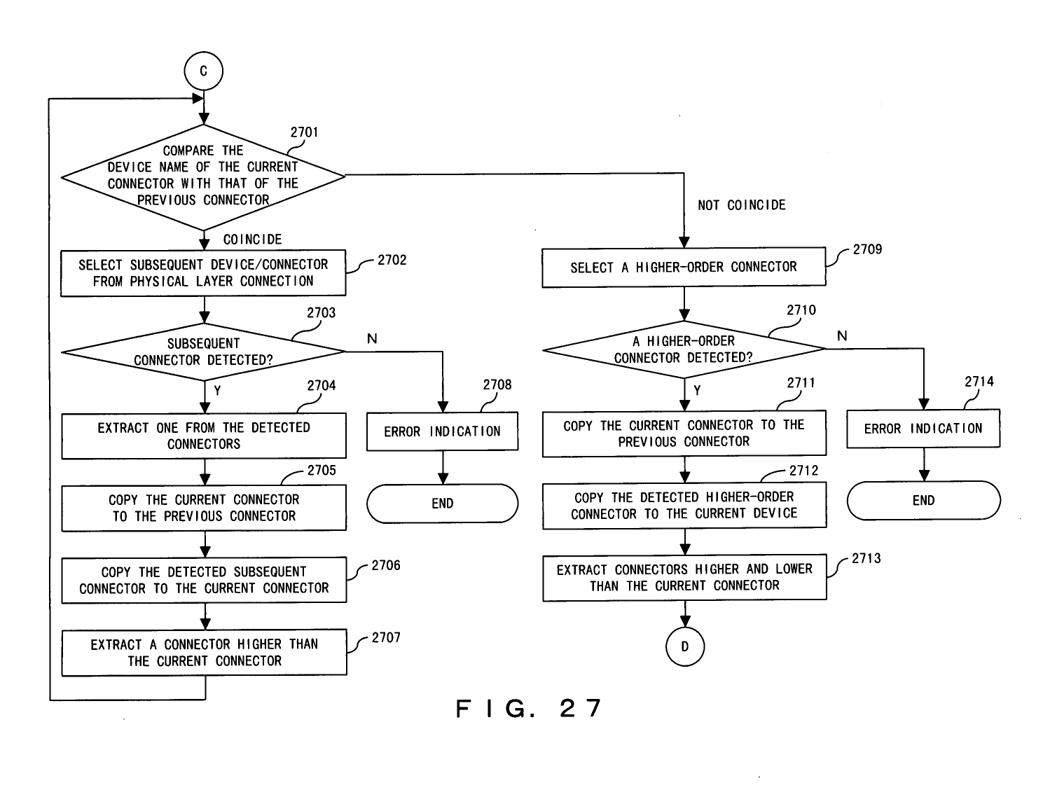

Then, a layer to which the current connector 2221 belongs is checked (step 2601 in FIG. 26) and it is determined whether the layer is a physical layer (step 2602). If the layer of the current connector 2221 is a physical layer, the device name of the current connector 2221 is compared with the device name of the previous connector 2222 (step 2701 in FIG. 27).

If the device name of the current connector 2221 does not coincide with that of the previous connector 2222, a connector is selected from higher-order layer connectors 2231 (step 2709), it is determined whether a connector is selected (step 2710). If a connector is not selected, the error is indicated (step 2714), and the process is terminated.

If a connector could be selected, the current connector 2221 is copied to the previous connector 2222 (step 2711), and the selected higher-order layer connector is copied to the current connector 2221 (step 2712). Then, by referring to the device setting information 2421, a connector in a layer higher than the current connector 2221 is extracted and is registered in the higher-order connector 2231. Simultaneously, a connector in a layer lower than the current connector 2221 is extracted and is registered in the lower-order layer connector 2232 (step 2713).

Then, the layer of the current connector 2221 is compared with the layer of the previous connector 2222 (step 2801 in FIG. 28). If the layer of the current connect 2221 is higher than the previous connector 2222, by referring to the device setting information 2421, destination is calculated, according to the setting information of a service in the layer of the current connector 2221, and a lower-order layer connector corresponding to the destination is selected (step 2802) Then, it is determined whether both destination and a lower-order layer connector are obtained (step 2803). If both destination and a lower-order layer connector are not obtained, the error is indicated (step 2807), and the process is terminated.

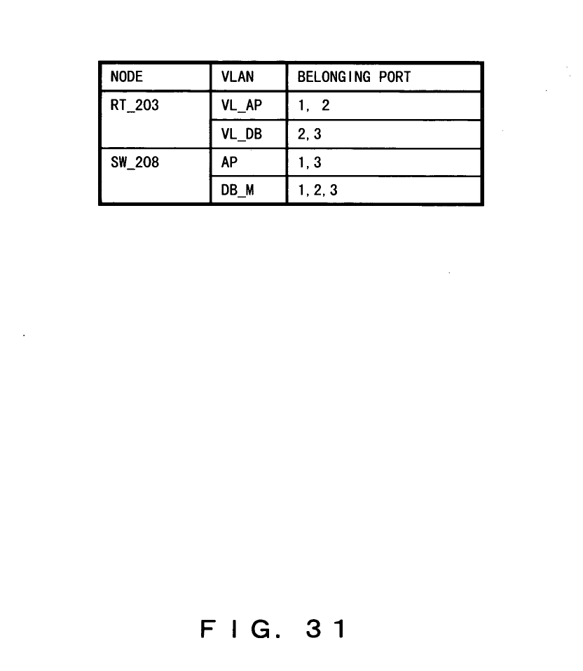

For example, if the current device is a switch and if the current connector 2221 is an MAC layer connector, in step 2802, a physical layer connector corresponding to the destination is determined, according to a MAC learning table, which is the setting information of a service in the MAC layer, of the switch. In this case, The VLAN setting of a switch, as shown in FIG. 31, is referred to. If both the current connect 2221 and the physical layer connector corresponding to the destination do not belong to the same VLAN, the determination is invalidated.

If both destination and a lower-order layer connector are obtained, the current connector 2221 is copied to the previous connector 2222 (step 2804), and the obtained lower-order layer connector is copied to the current connector 2221 (step 2805). Then, by referring to the device setting information 2421, a connector in a layer higher than the current connector 2221 is extracted and is registered in the higher-order layer connector 2231. Simultaneously, a connector in a layer lower than the current connector 2221 is extracted and is registered in the lower-order layer connector 2232 (step 2806).

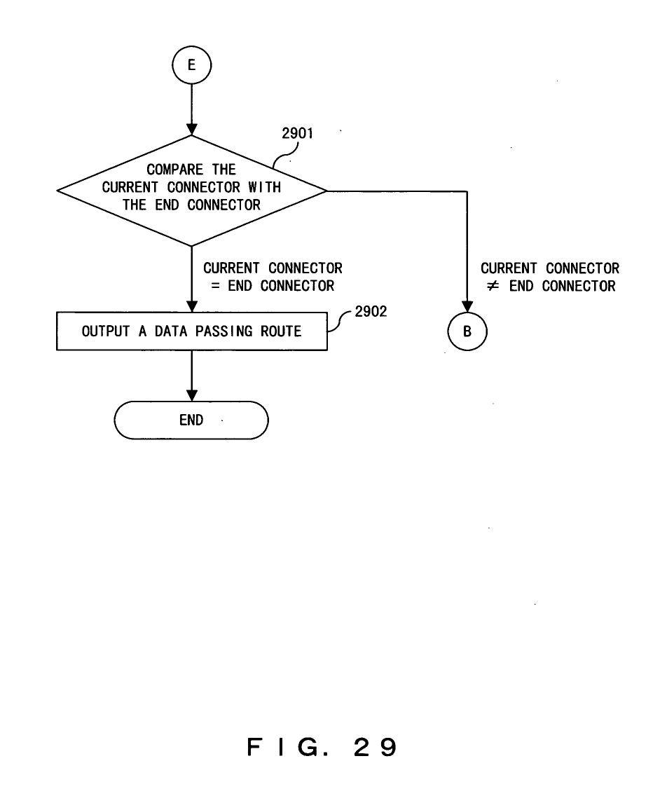

Then, the current connector 2221 is compared with an end-point connector (step 2901 in FIG. 29). If the current connector 2221 coincides with the end-point connector, information about connectors traced in the course of the searching process up to this point is outputted as data passing route 2204 (step 2902), and the process is terminated. If the current connector 2221 does not coincide with the end-point connector, the process in step 2601 and after of FIG. 26 is repeated.

If in step 2801 of FIG. 28, the current connector 2221 is lower than the previous connector 2222, by referring to the device setting information 2421, destination is calculated, according to the service setting information of the layer of the current connector 2221, and a lower-order layer connector corresponding to the destination is selected (step 2808). Then, it is determined whether both destination and a lower-order layer connector are obtained (step 2809).

If both destination and a lower-order layer connector are obtained, the current connector 2221 is copied to the previous connector 2222 (step 2810), and the obtained lower-order layer connector is copied to the current connector 2221 (step 2811). Then, by referring to the device setting information 2421, a connector in a layer higher than the current connector 2221 is extracted and is registered in the higher-order layer connector 2231. Simultaneously, a connector in a layer lower than the current connector 2221 is extracted and is registered in the lower-order layer connector 2232 (step 2812). After that, the process in steps 2901 and after of FIG. 29 is performed.

If in step 2809, the destination is not obtained or if it is necessary to dynamically obtain the destination by a name resolution method or the like, the subsequent route determination unit 2211 asks the dynamic information calculation unit 2212 to search for the destination, according to dynamic information (step 2413). Then, it is determined whether the destination is obtained from the dynamic information calculation unit 2212 (step 2814). If the destination is obtained, the process in step 2810 and after is performed.

If the destination could not be obtained, a higher-order layer connector linked with the current connector 2221 is selected without modifying the current destination (step 2815), and it is determined whether the connector is selected (step 2816). If the connector is selected, the connector is set to the destination (step 2817), and the process in step 2810 and after is performed. If the connector could not be obtained, the error is indicated (step 2818), and the process is terminated.

If in step 2701 of FIG. 27, the device name of the current connector 2221 coincides with that of the previous connector 2222, by referring to topology 2202 covering a plurality of layers, a connector of a device belonging to the physical connection including the current connector 2221 is selected (step 2702), and it is checked whether the connector is selected (step 2703). If the connector cannot be selected, the error is indicated (step 2708), and the process is terminated.

If the connector could be selected, one of the selected physical layer connectors is extracted (step 2704), the current connector 2221 is copied to the previous connector 2222 (step 2705), and the extracted connector is copied to the current connector 2221 (step 2706). Then, by referring to the device setting information 2421, one or more connector in a layer higher than the current connector 2221 are extracted and are registered in the higher-order layer connector 2231 (2707). Then, the process in step 2701 and after is repeated.

If in step 2602 of FIG. 26, the layer of the current connector 221 is not a physical layer, the process in step 2801 and after is performed.

Next, the destination searching process which is performed in step 2408 of FIG. 24 and step 2813 of FIG. 28 is described with reference to FIG. 30. When asking the dynamic information calculation unit 2212 to search for destination, the subsequent route determination unit 2211 transfers information about both the current connector layer 3011 and the current destination 3012 to the dynamic information calculation unit 2212. In step 2408, the end-point destination is transferred as the current destination 3012, whereas in step 2813, the previous destination is transferred as the current destination 3012.

The dynamic information calculation unit 2212 before hand extracts the routing table 3012 of each device, the address resolution protocol (ARP) table 3022 of each device, the MAC learning table 3023 of a switch, the host name of each device 3024, the IP address 3025 of each device and the MAC address 3026 of each device from the setting information 153, and stores them in the memory. The ARP table 3022 relates the IP address of a device to its MAC address.

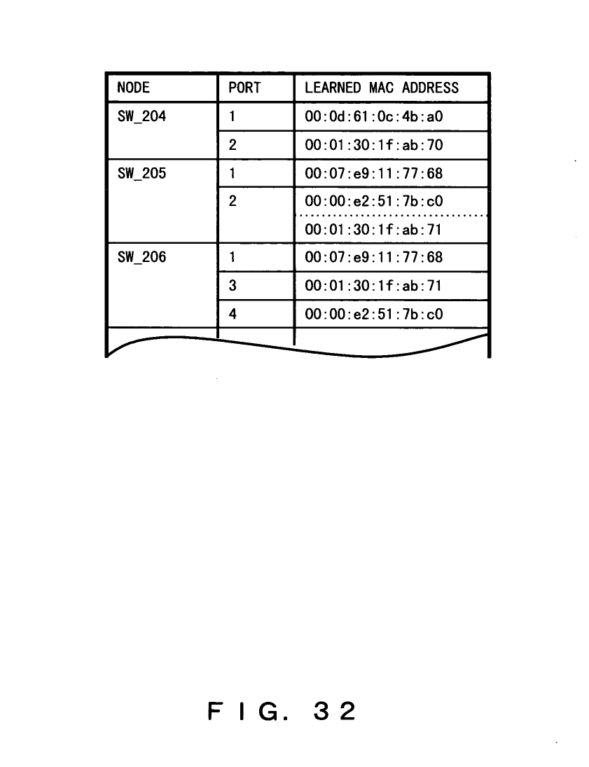

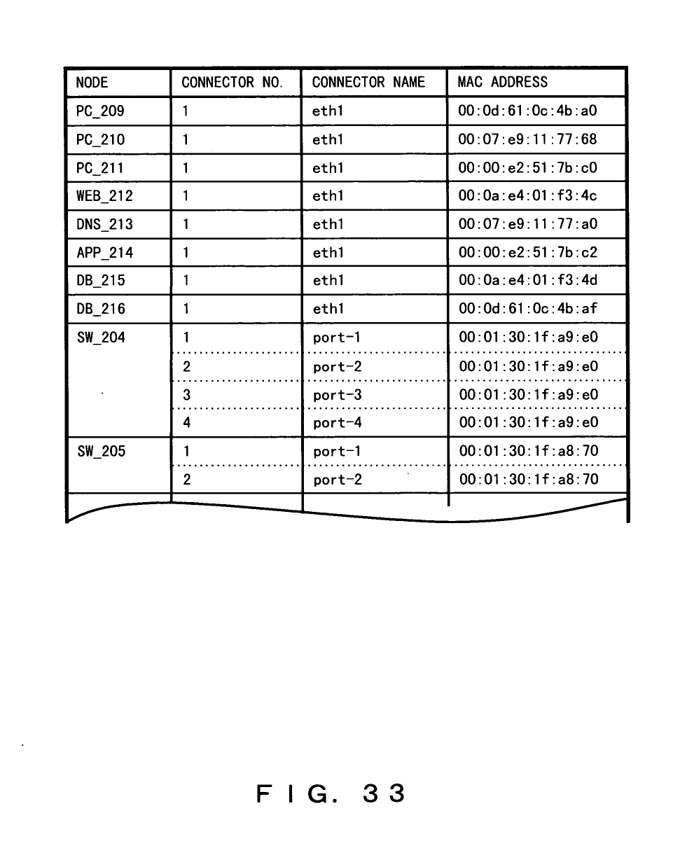

In the case of the network shown in FIG. 6, the MAC learning table 3023 of a switch and the MAC address 3026 of each device, for example, contain data shown in FIGS. 32 and 33, respectively. The MAC learning table shown in FIG. 32 registers learned MAC addresses for each port of each node, and the MAC address shown in FIG. 33 registers connector numbers, connector names and MAC addresses for each connector of each node.

The dynamic information calculation unit 2212 firstly reads the layer 3011 of the current connector and the current destination 3012 (step 3001). Then, the dynamic information calculation unit 2212 searches for the destination of a lower-order layer corresponding to the destination in the layer 3011 of the current connector referring to the routing table 3012 of each device, the ARP table 3022 of each device, the MAC learning table 3023 of a switch, the host name of each device 3024, the IP address 3025 of each device and the MAC address 3026 of each device (step 3002), and checks whether the destination is obtained (step 3003).

For example, if the layer 3011 of the current connector is an IP layer and the destination of a MAC layer lower than the IP layer is searched for in the following procedure.
(1) A connector with the same IP address as that of the current address 3012 is searched for in the IP addresses 3025 of each device.
(2) The MAC address of an MAC layer connector linked in the lower order of the connector calculated in (1) is obtained from the MAC address 3026 of each device.
(3) A lower-order connector corresponding to the destination IP address is obtained from the routing table 3021 of each device, and is designated as a subsequent connector.

If the layer 3011 of the current connector is an MAC layer, the destination of a physical layer lower than the MAC layer is searched for as follows.
(1) A connector for which the MAC address of the current destination 3012 has been learned is searched for in the MAC learning table 3023 of a switch.
(2) A physical layer connector linked in the lower order of the connector calculated in (1) is calculated, and is designated as a subsequent connector.
(3) Since a physical layer does not require a destination, the destination is not changed.

If the destination of a lower-order layer is obtained, the dynamic information calculation unit 2212 stores the destination and connector information in the memory and transfers the information to the subsequent route determination unit 2211 (step 3004), and terminates the process. If the destination is not obtained, the dynamic information calculation unit 2212 notifies the subsequent route determination unit 2211 of that, and terminates the process.

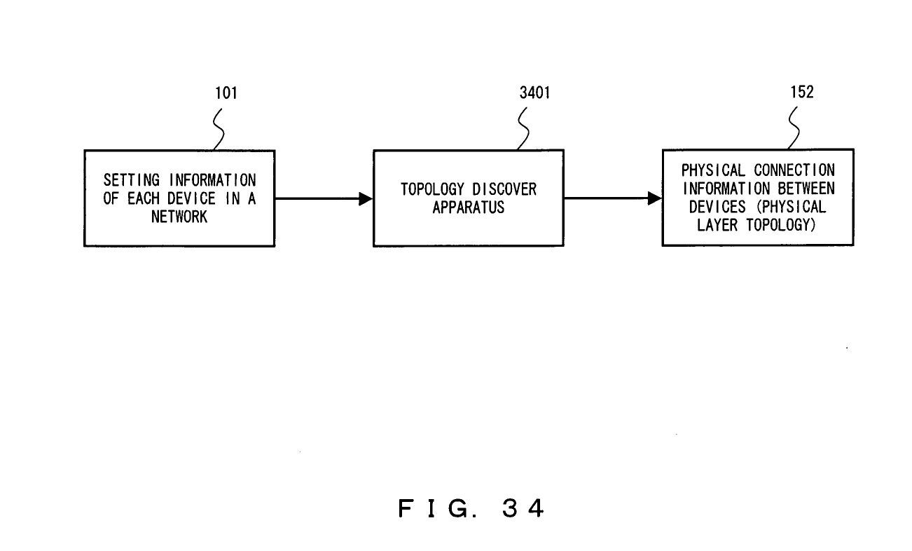

Next, the topology discover apparatus for discovering the physical connection of devices in a network is described. FIG. 34 shows such a topology discover apparatus. The topology discover apparatus 3401 shown in FIG. 34 searches for the physical connection information 152 of devices, according to setting information 101 obtained from each device in the network and outputs the information. Since according to such a topology discover apparatus, all physical connections can be automatically calculated, time and effort needed to input the physical connection information 152 in configuration management can be saved. Therefore, a process ranging from the detection of a device up to topology discover can be accurately performed without the time and effort of the manager.

FIG. 35 shows the configuration of the topology discover apparatus 3401 shown in FIG. 34. The topology discover apparatus 3401 shown in FIG. 35 is configured using, for example, an information processing device provided with a CPU and a memory, and comprises a physical connection discover unit 3501. The physical connection discover unit 3501 includes an inter-switch connection discover unit 3511 and a switch-terminal connection discover unit 3512. The physical connection discover unit 3501 searches for a physical connection using the setting information 153 of each device as input, and outputs the physical connection information 152 of devices through a display or the like.

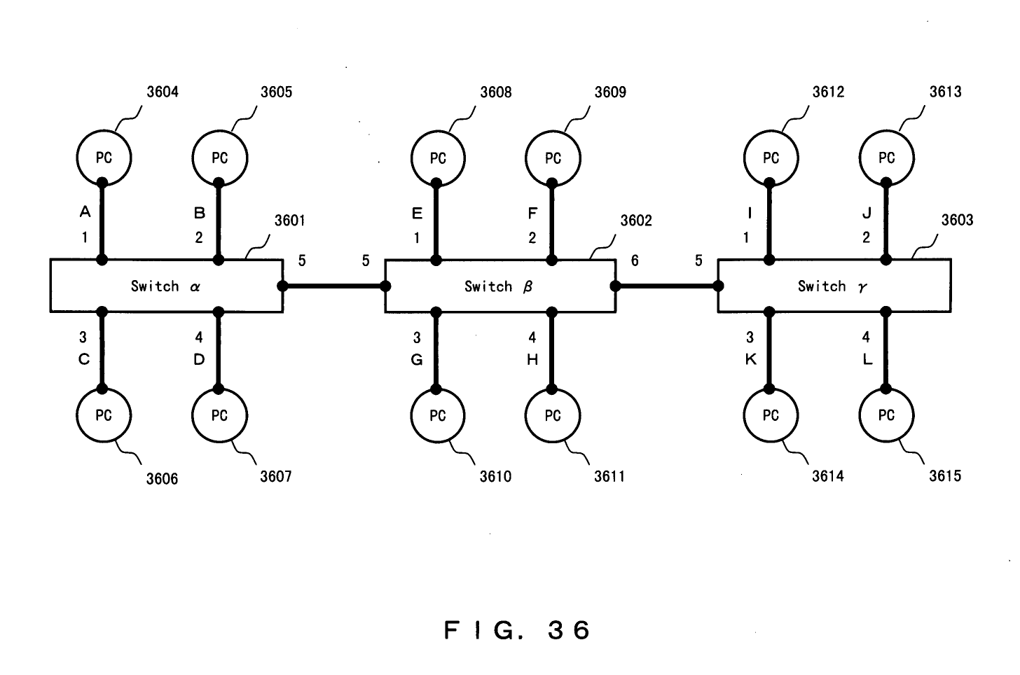

FIG. 36 shows an example of physical connections in a network to be searched. This network comprises switches 3601 through 3603 and personal computers 3604 through 3615.

The switch 3601 (switch α) comprises connectors 1 through 5. The connectors 1, 2, 3 and 4 are connected to the personal computers 3604, 3605, 3606 and 3607, respectively, and the connector 5 is connected to the switch 3602.

The switch 3602 (switch β) comprises connectors 1 through 6. The connectors 1, 2, 3 and 4 are connected to the personal computers 3608, 3609, 3610 and 3611, respectively, and the connectors 5 and 6 are connected to the switches 3601 and 3603, respectively.

The switch 3603 (switch γ) comprises connectors 1 through 5. The connectors 1, 2, 3 and 4 are connected to the personal computers 3612, 3613, 3614 and 3615, respectively, and the connector 5 is connected to the switch 3602.

The MAC addresses of the personal computers 3604, 3605, 3606, 3607, 3608, 3609, 3610, 3611, 3612, 3613, 3614 and 3615 are A, B, C, D, E, F, G, H, I, J, K and L, respectively.

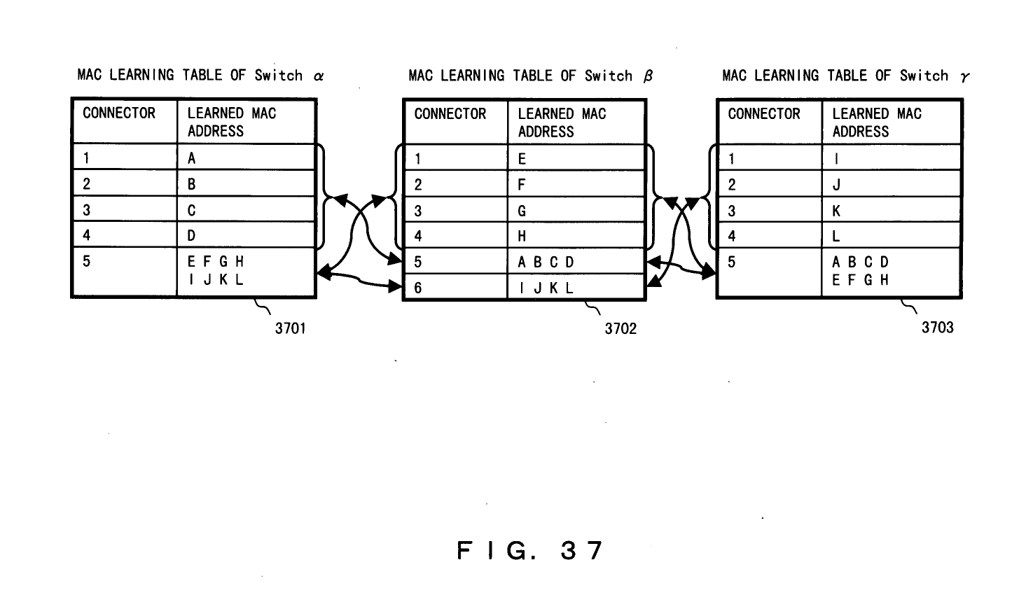

The switches 3601, 3602 and 3603 comprise MAC learning tables 3701, 3702 and 3703, respectively, as shown in FIG. 37, in order to provide a switching service. These MAC learning tables register the respective learned MAC addresses of the computers 3604 through 3615 for each connector.

When the respective device setting information of the switches 3601 through 3603 or the personal computers 3604 through 3615 is inputted, the physical connection discover unit 3501 obtains physical connection information 152 as follows.

The inter-switch connection discover unit 3511 extracts the MAC learning tables 3701, 3702 and 3703 from the device setting information of a switch, and searches for the physical connection of switches referring to these MAC learning tables.

Between two adjacent switches, MAC addresses learned about a connector of one switch linked to the other switch is the sum of MAC addresses learned about connectors of the other switch except a connector linked to the one switch.

For example, in the case of switch α, as shown in FIG. 37, for the connector 5 linking switch α and its adjacent switch β, MAC addresses E, F, G, H, I, J, K and L learned for connectors except the connector 5 of switch βare learned. As to switches β and γ, MAC addresses are similarly learned.

The inter-switch connection discover unit 3511 calculates the physical connection of switches by checking the respective MAC address learning tables of all switches in the network and determining whether comparison using a logical sum is successful for each port of a MAC address learned about each connector of the switch.

The switch-terminal connection discover unit 3512 searches for the physical connection between a specific switch and each personal computer, based on the MAC addresses of the personal computers 3604 through 3615 and the search result of the inter-switch connection discover unit 3511. In this case, the switch-terminal connection discover unit 3512 searches for a connector for which a MAC address of a device other than switch (terminal) in the network, of connectors not used for the connection between two switches in the MAC address learning table of each switch, and calculates physical connection between the connector and a terminal.

Since physical connection is one to one, if as a result of the search, there is one-to-multiple connection, it is estimated that there is another device in the connection. Another device means a device for providing a service in the MAC layer or a layer lower than the MAC layer, such as a switch, a repeater hub or the like which is not managed.

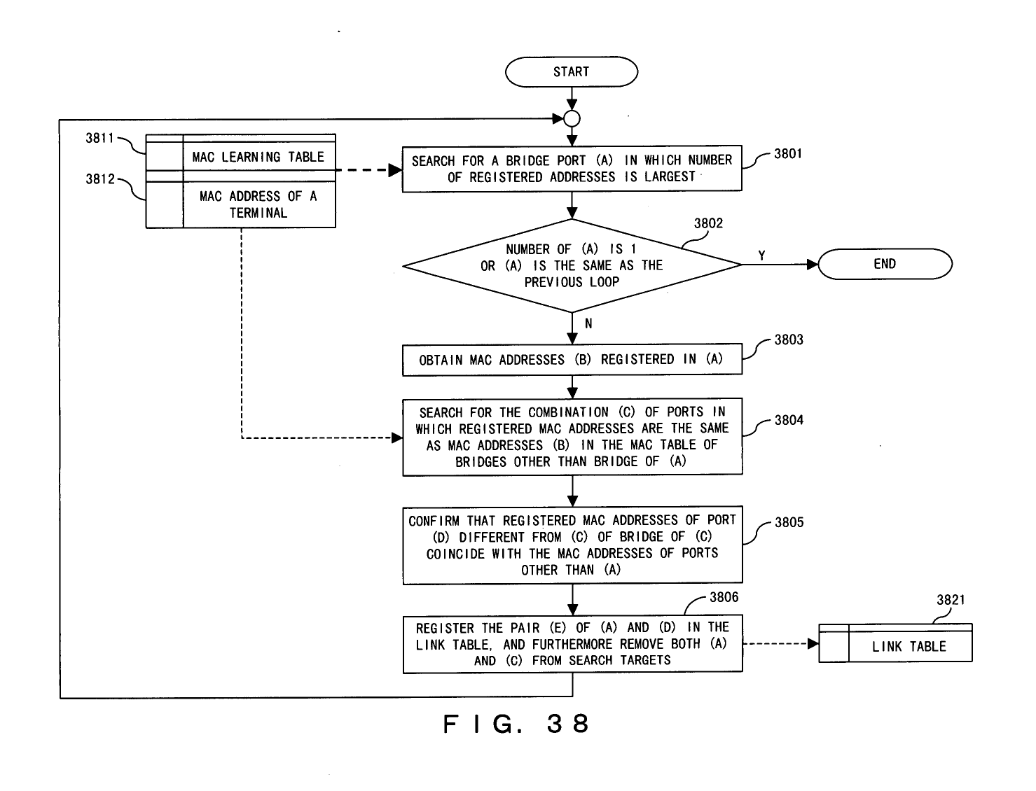

FIG. 38 is a flowchart showing the inter-switch connection search process of the inter-switch connection discover unit 3511. The inter-switch connection discover unit 3511 beforehand extracts both the MAC learning table 3811 of a bridge (switch) and the MAC address 3812 of a terminal from the setting information 153, and stores them in the memory. Then, the loop process in steps 3801 through 3806 is repeated.

The inter-switch connection discover unit 3511 firstly, by referring to the MAC learning table 3811, searches a bridge port (connector) in which the registered number of MAC addresses is a maximum in the MAC learning tables of all bridges, and stores the port in the memory as (A) (step 3801). Then, the inter-switch connection discover unit 3511 checks whether the number of registered addresses of port (A) is one and whether the port (A) is the same as that of the previous loop (step 3802).

If the number of registered addresses of port (A) is not one and if the port (A) is different from that of the previous loop, MAC addresses registered in the port (A) are obtained, and are stored in the memory as (B)(step 3803).

Then, by referring to the MAC learning table 3811, the inter-switch connection discover unit 3511 searches for a combination of ports in which the logical sum of the registered MAC addresses coincides with MAC addresses (B), in the MAC learning table of a bridge other than one with port (A), and stores the combination in the memory as (C) (step 3804).

Then, by referring to the MAC learning table of a bridge with port combination (C), the inter-switch connection discover unit 3511 confirms that MAC addresses registered in one port (D) other than (C) coincide with the combination of MAC addresses of ports other than port (A), which are registered in the MAC learning table of the bridge with port (A) (step 3805).

Then, the inter-switch connection discover unit 3511 determines that port (A) is connected to port (D), registers the pair (E) of ports (A) and (D) in the link table 3821 of the memory as one link and removes port (A) and port combination (C) from search targets (step 3806). Then, the process in step 3801 and after is repeated. If in step 3802 the number of registered addresses of port (A) is one or if port (A) is the same as that of the previous loop, the process is terminated.

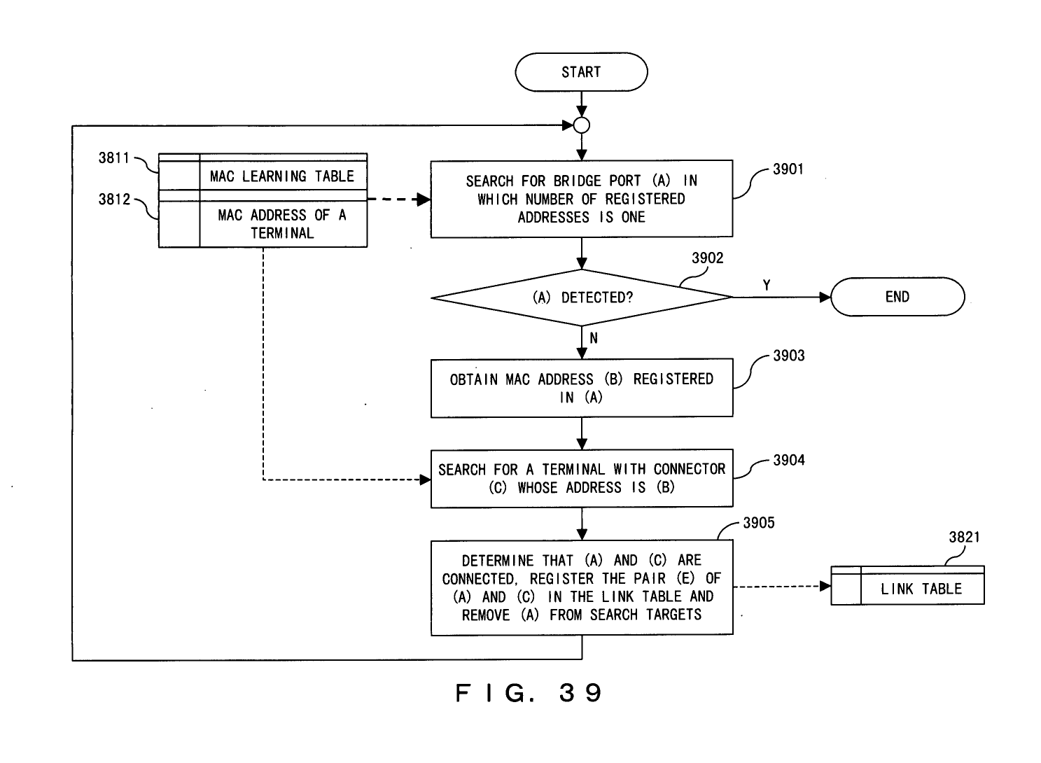

FIG. 39 is a flowchart showing the switch-terminal connection searching process of the switch-terminal connection discover unit 3512. The switch-terminal connection discover unit 3512 repeats the loop process in steps 3901 through 3905.

The switch-terminal connection discover unit 3512 firstly, by referring to the MAC learning table 3811, searches for a port in which the number of registered MAC addresses is one in the MAC learning tables of all bridges (step 3901), and checks whether port (A) is obtained (step 3902).

If port (A) is obtained, the switch-terminal connection discover unit 3512 stores the port in the memory as (A), obtains the MAC address registered in the port (A) and stores the MAC address in the memory as (B) (step 3903).

Then, by referring to the MAC address 3812 of the terminal, the switch-terminal connection discover unit 3512 searches for a terminal with a connector whose MAC address is (B), and stores the connector in the memory as (C) (step 3904). Then, the switch-terminal connection discover unit 3512 determines that ports (A) and (C) are connected, registers the pair (E) of port (A) and connector (C) in the link table 3821 as one link and removes port (A) from the search targets (step 3905). Then, the process in step 3901 and after is repeated. If in step 3902 port (A) is not obtained, the process is terminated.

The physical connection discover unit 3501 outputs the information about the link table 3821 thus generated as physical connection information 152.

If the topology discover apparatus 102 shown in FIG. 5 is provided with such a physical connection discover unit 3501, topology 154 covering a plurality of layers can be generated without inputting the physical connection information 152.

Although in the above-mentioned preferred embodiments, five layers as shown in FIG. 3 is used as a hierarchical structure of a communication function, the present invention is not limited to this hierarchical structure, and another hierarchical structure is also applicable.

By the way, the topology discover apparatus 102 shown in FIG. 5, the topology discover apparatus 2102 shown in FIG. 22 and the topology discover apparatus 3401 shown in FIG. 35 can be configured for example, using an information processing device (computer) as shown in FIG. 40. The information processing device shown in FIG. 40 comprises a CPU (central processing unit) 4001, a memory 4002, an input device 4003, an output device 4004, an external storage device 4005, a medium driving device 4006, a network connection device 4007, which are all connected to each other by a bus 4008.

The memory 4002 includes a read-only memory (ROM) a random-access memory (RAM) and the like, and stores a program and data used for the process. The CPU 4001 performs a necessary process by utilizing the memory and executing the program.

The topology discover unit 151, MAC layer topology discover unit 161, IP layer topology discover unit 162, TCP/UDP layer topology discover unit 163 and application layer topology unit 164 which are shown in FIG. 5, the route discover unit 2201, subsequent route determination unit 2211 and dynamic information calculation unit 2212, which are shown in FIG. 22, and the physical connection discover unit 3501, inter-switch connection discover unit 3511 and switch-terminal connection discover unit 3512, which are shown in FIG. 35 correspond to the program stored in the memory 4002.

The input device 4003 is used, for example, for a user to input instructions and information. The output device 4005 includes a display, a printer, a speaker and the like, and is used to output inquiries and process results to the user and the like.

The external storage device 4005 includes a magnetic disk, an optical disk, a magneto-optical disk, a tape device and the like. The information processing device stores the program and data in this external storage device 4005 beforehand, and uses them by loading them onto the memory 4002, as requested.

The medium driving device 4006 drives a portable storage medium 4009 and accesses its recorded contents. The portable storage medium is an arbitrary computer-readable storage medium, such as a memory card, a flexible disk, an optical disk, a magneto-optical disk or the like. The operator stores the program and data in this portable storage medium 4009 beforehand, and uses them by loading them onto the memory 4002, as requested.

The network connection device 4007 is connected to an arbitrary communication network, such as a LAN (local area network), the Internet or the like, and performs a data conversion accompanying communication. The information processing device receives the program and data from an external device through the network connection device 4007, as requested, and uses them by loading them onto the memory 4002.

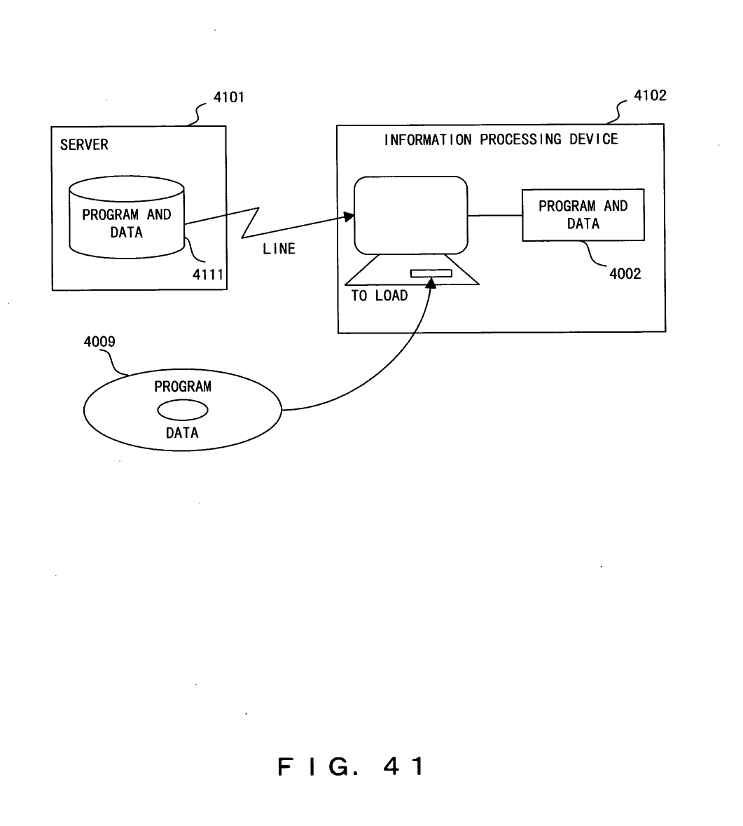

FIG. 41 shows how to provide the information processing device shown in FIG. 40 with the program and data. The program and data stored in the portable storage medium 4009 or the database 4111 of a sever 4101 is loaded onto the memory 4002 of the information processing device 4102. The server 4101 generates a propagation signal used to propagate the program and data, and transmits them to the information processing device 4102 through an arbitrary transmission medium in the network. The CPU 4001 performs a necessary process using the data and executing the program.

1. A topology discover apparatus for searching for topology among a plurality of devices composing a communication network with a communication function having a hierarchical structure composed of a plurality of layers, comprising:
a storage device for storing device setting information of the plurality of devices;
a generation device for grouping connections included in topology of a lower-order layer of the plurality of layers according to the device setting information to generate an information reach range in a higher-order layer, and generating topology of the higher-order layer based on the information reach range; and
an output device for outputting information about the generated topology.

2. The topology discover apparatus according to claim 1, further comprising:
an input device for inputting information about topology of the lowest-order layer of the plurality of layers,
wherein
said generation device repeats a process of sequentially generating topology of a higher-order layer starting from the lowest-order layer to generate topology of each layer ranging from a layer immediately higher than the lowest-order layer up to the highest-order layer.

3. The topology discover apparatus according to claim 1, further comprising:
a route discover device for searching for a passing route of data of a designated application service between two devices in the communication network, according to both the device setting information and information about the respective topology of the lower-order and higher-order layers,
wherein
said output device outputs information about the passing route of the data.

4. A topology discover apparatus for discovering topology among a plurality of devices composing a communication network, comprising:
a storage device for storing device setting information of the plurality of devices; and
a generation device for generating information about physical connections among the plurality of devices, according to information about a media access control address of each interface of each device included in the device setting information.

5. A computer-readable storage medium on which is recorded a program for enabling a computer to search for topology among a plurality of devices composing a communication network with a communication function having a hierarchical structure composed of a plurality of layers, said program enabling the computer to perform:
grouping connections included in topology of a lower-order layer of the plurality of layers, according to device setting information of the plurality of devices stored in a storage device to generate a information reach range in a higher-order layer;
generating topology of the higher-order layer, based on the information reach range; and
outputting information about the generated topology.

6. The storage medium according to claim 5, wherein
said program enables the computer to input information about topology of the lowest-order layer of the plurality of layers, repeats a process of sequentially generating topology of a higher-order layer starting from the lowest-order layer to generate topology of each layer ranging from a layer immediately higher than the lowest-order layer up to the highest layer.

7. The storage medium according to claim 5, wherein
said program enables the computer to search for a passing route of data of a designated application service between two devices in the communication network, according to both the device setting information and information about respective topology of the lower-order and higher-order layers and output the information of the passing route of the data.

8. The storage medium according to claim 7, wherein
said program enables the computer to store both information about a current interface and information about respective interfaces of layers higher and lower than the current interface in a process of searching for the passing route in said storage device, and search for the passing route using the respective interfaces of the higher and lower layers as search target candidates.

9. The storage medium according to claim 5, wherein
said program enables the computer to generate a connection of a media access control layer of the plurality of layers by grouping connections included in topology of a physical layer of the plurality of layers according to link aggregation information in the device setting information, generate an information reach range by collecting connections of the media access control layer, and generate topology of the media access control layer based on the information reach range.

10. The storage medium according to claim 9, wherein
said program enables the computer to group interfaces of the media access control layer which belongs to each virtual local area network according to virtual local area network information in the device setting information, and generate an information reach range by collecting connections of the media access control layer for each interface group of the media access control layer.

11. The storage medium according to claim 9, wherein
said program enables the computer to generate the topology of the physical layer according to the device setting information.

12. The storage medium according to claim 5, wherein
said program enables the computer to generate a connection of the Internet protocol layer by grouping interfaces of an Internet protocol layer of the plurality of layers according to Internet protocol address information in the device setting information, generate an information reach range by grouping connections of the Internet protocol layer according to routing information in the device setting information, and generate topology of the Internet protocol layer based on the information reach range.

13. The storage medium according to claim 5, wherein
said program enables the computer to generate a connection of a transmission control protocol/user datagram protocol layer of the plurality of layers by collecting interfaces of the transmission control protocol/user data program protocol layer, of a device included in an information reach range of an Internet protocol layer of the plurality of layers, generate an information reach range by grouping connections of the transmission control protocol/user datagram protocol layer according to packet filtering information in the device setting information, and generate topology of the transmission control protocol/user datagram protocol layer based on the information reach range.

14. The storage medium according to claim 5, wherein
said program enables the computer to generate a connection of an application layer of the plurality of layers by collecting communicable interfaces of the application later, of a device included in an information reach range of a transmission control protocol/user datagram protocol layer of the plurality of layers, generate an information reach range by grouping connections of the application layer according to application information in the device setting information, and generate topology of the application layer based on the information reach range.

15. A computer-readable storage medium on which is recorded a program for enabling a computer to search for topology among a plurality of devices composing a communication network, said program enabling the computer to perform:
extracting information about a media access control address of each interface of each device from device setting information of the plurality of devices, stored in a storage device; and
generating information about physical connections among the plurality of devices, according to the extracted information about the media access control address.

16. The storage medium according to claim 15, wherein
said program enables the computer to extract information about a media access control learning table of a switch included in the plurality of devices as the information about the media access control address, calculate a port in which the most media access control addresses in the media access control learning tables of all switches are registered, and when a plurality of media access control addresses registered in the obtained port coincides with a combination of media access control addresses registered in a plurality of ports in a media access control learning table of a first switch different from a second switch with the obtained port and a combination of media access control addresses registered in a plurality of ports other than the obtained port in a media access control learning table of the second switch coincides with a plurality of media access control addresses registered in a port in the media access control learning table of the first switch, register a pair of the obtained port of the second switch and the port of the first switch in the storage device as a physical connection.

17. The storage medium according to claim 16, wherein
said program enables the computer to calculate a port in which only one media access control address is registered in the media access control learning tables of all switches, calculate a terminal with an interface having a media access control address registered in the obtained port, of the plurality of devices, and register a pair of the interface of the obtained terminal and the obtained port in the storage device as a physical connection.

18. A propagation signal for propagating a program for enabling a computer to search for topology among a plurality of devices composing a communication network with a communication function having a hierarchical structure composed of a plurality of layers, said program enabling the computer to perform:
grouping connections included in topology of a lower-order layer of the plurality of layers, according to device setting information of the plurality of devices stored in a storage device to generate a information reach range in a higher-order layer;
generating topology of the higher-order layer, based on the information reach range; and
outputting information about the generated topology.

19. A propagation signal for propagating a program for enabling a computer to search topology among a plurality of devices composing a communication network, said program enabling the computer to perform:
extracting information about a media access control address of each interface of each device from device setting information of the plurality of devices, stored in a storage device; and
generating information about physical connections among the plurality of devices, according to the extracted information about the media access control address.

20. A topology discovering method for discovering topology among a plurality of devices composing a communication network with a communication function having a hierarchical structure composed of a plurality of layers, comprising:
grouping connections included in topology of a lower-order layer of the plurality of layers, according to device setting information of the plurality of devices to generate a information reach range in a higher-order layer;
generating topology of the higher-order layer, based on the information reach range; and
outputting information about the generated topology.

21. A topology discover method for discovering topology among a plurality of devices composing a communication network, comprising:
extracting information about a media access control address of each interface of each device from device setting information of the plurality of devices; and
generating information about physical connections among the plurality of devices, according to the extracted information about the media access control address.

22. A topology discover apparatus for discovering topology among a plurality of devices composing a communication network with a communication function having a hierarchical structure composed of a plurality of layers, comprising:
storage means for storing device setting information of the plurality of devices;
generation means for grouping connections included in topology of a lower-order layer of the plurality of layers according to the device setting information to generate an information reach range in a higher-order layer, and generating topology of the higher-order layer based on the information reach range; and
output means for outputting information about the generated topology.

23. A topology discover apparatus for discovering topology among a plurality of devices composing a communication network, comprising:
storage means for storing device setting information of the plurality of devices; and
generation means for generating information about physical connections among the plurality of devices, according to information about a media access control address of each interface of each device included in the device setting information.
